(19) United States
(12) Patent Application Publication
(10) Pub. No.: US 2026/0162427 A1
(43) Pub. Date: Jun. 11, 2026

(54) SYSTEM AND A METHOD FOR CONTEXT BASED IMAGE CLASSIFICATION, ORGANIZATION AND RETRIEVAL BASED ON RECOGNITION AND ANALYSIS OF GIVEN SUBJECTS OR OBJECTS OBJECTIVES AND RECOMMENDATIONS BASED ON EXTENT OF OBJECTIVES FULFILLMENT

(71) Applicant: Abhijit Anant Telang, Pune (IN)

(72) Inventor: Abhijit Anant Telang, Pune (IN)

(21) Appl. No.: 19/083,558

(22) Filed: Mar. 19, 2025

Related U.S. Application Data
(60) Provisional application No. 63/730,011, filed on Dec. 10, 2024.

(51) Int. Cl. G06V 20/00; G06F 16/532; G06V 10/764

(52) U.S. Cl. CPC G06V 20/35; G06F 16/532; G06V 10/764

(57) ABSTRACT

The invention is a context based image classification, organization and retrieval system that categorizes images based on emotional, behavioral, attire, location, person-person, person-object, body language, and contextual cues related to either user-defined or inferred goals and milestones. The system comprises a user interface for inputting goals and milestones; a context recognizer for analyzing images and extracting intent; a milestone generator for identifying significant events; an aspect recognizer that analyses visual features; an aspect library storing predefined frameworks; a visual analysis component that employs advanced computer vision techniques; a query generator for constructing detailed image searches; a text filter and classifier for refining queries; a query processing unit for optimizing search parameters; an image description builder; an image and search recognizer; a score calculator to assess relevance; an image presentation system for organized outputs; and a nudge/prompter module for providing recommendations. System facilitates creation of personalized visual narratives across various devices.

This application claims the benefit of U.S. Provisional Application No. 63/730,011 filed on Dec. 10, 2024. The present invention relates to the field of image processing and computer vision. Particularly, the invention relates to a Context based image classification, organization and retrieval system that categorizes and retrieves images based on content, context, and user-defined goals to create personalized visual narratives and recommendations, where the Context collectively refers to the objectives as either defined or inferred for a given Subject or Object.

### TECHNICAL FIELD OF THE INVENTION

### Background of the Invention

The field of automatic image curation and storytelling is increasingly important in today's digital landscape, where users are often overwhelmed by the sheer volume of visual content. The existing methods for selecting and categorizing images for creating narratives often require manual intervention, which can limit the user experience, and the overall effectiveness of the narrative constructed. The reason being that these methods of image search and categorization primarily rely on metadata including tags and captions. While they may utilize machine learning algorithms to detect faces and objects, they are not concerned with progression of Subject in terms of motion or locations traversed, expressions, interactions and supporting aspects such as attires and backdrops. Similarly, they are not concerned about progression of an observed object along an identified dimension. While existing approaches allow the users to search for images containing specific subjects or objects, they end up prioritizing user engagement and popularity metrics to influence resulting image organization, often overlooking the specific objectives and associated progressive steps within the greater context tied to the subject of interest. Hence the resulting narratives from existing methods or mechanisms end up being grouped around a given subject, a subject with another subject/s, with other object/s, around a timeline or location. Narratives are not thus about how a given subject or object has accomplished a given objective within a given or inferred context.

The prior art US20190220483A1 discloses the images are intelligently selected to create image narratives. Instead of a user having to manually search and locate images to view, the images to associate with a particular image narrative are programmatically determined. Many types of image narratives may be created. For example, one image narrative may show images that include both a first user and a second user over some period. Another image narrative may show images that relate to an activity that a first user enjoys or an event that included the user (e.g., a graduation). The tags and metadata associated with the images of the user are analyzed to determine the tags that are important to the user. For example, the importance might be determined based on the frequency of the tags within the images. After creation, the user may select one of the image narratives to view the associated images. In order to identify images for inclusion or exclusion. The prior art relies on generation or contributing of tags to score, which in turn is based on extent of recurrence-time based, location based, or association based or activity based. Prior art does not discover the typical milestones and stages within a given milestone and then the various successive advancements in aspects that are expected to change as the given subject or object goes on to accomplish.

The prior art lacks a comprehensive system with components like a query generator, text filter, classifier, and image description builder, and does not track progression through milestones, such as location aspects, or use recursive querying methods to help users find or upload missing images for their narrative. while it may recognize and utilize the aspects of location and time, and social association such as “friend or best friend or parents” etc, it does not decompose image into various aspects particularly the body language, and social interactions such as wave, hand shake, hug, embrace, and sequence based on their successive progression. It does not consider the filtering component that can be fine tuned to zoom in or zoom out on such progression. i.e. whether one should find images that show case A. Zoom in: how two people arrived (further decomposed into got down from car, greeted, walked up the stairs, entered at a designated room, waved at each other, shook hands, signed an accord, and exchanged signed documents) B. Zoom out: how two people shook hands, signed an accord and exchanged documents. Prior art does not seek to find, sequence and identify missing images based on a given subject's or object's accomplishment of given objectives which in turn are broken down into milestones and how each aspect was put through successive progression to accomplish that particular milestone or objective. Simply put, in the context of graduation: prior art can possibly find the following: 1. images containing subject prior to or after in terms of time scale. 2. images containing subject frequently seen together with friends/family/relatives. (graduation pic with family members and close friends) 3. images containing subject doing a specific activity that is frequently done alone/together. (such as hiking or rafting with those friends who typically accompanied them during this time period or at airport with select friends and family members.). However, prior art will not be able to find and sequence images specifically those relating to milestones leading to graduation. For instance, prior art will not be able to discover and sequence various milestones the subject had to accomplish prior to fulfillment of this objective such as 1. Taking the final exam 2. Receiving Grades 3. Applying for graduation 4. Walk towards the Dias. 5. Receiving the Degree/Diploma. OR 1. Receiving the Admit Letter. 2. Selecting the school 3. Travelling to School. 4. Registering for classes 5. First day of classes and more so.

The prior art US20230146144A1 discloses the Implementations are described herein for automatically annotating or curating digital images using various signals generated by individual users, in addition to or instead of content of the digital images themselves, thereby to enable the digital images to be retrieved from a searchable database based on their annotations. Techniques are described herein for identifying events associated with a user, e.g., based on natural language input provided by a user, and automatically classifying/annotating images inferred to be related to those events.

The prior art does not describe milestone tracking, accurate progression of aspects along the stages and milestones leading to fulfillment of objectives representation or evaluating image match based on alignment with aspects and stages. It also lacks image sorting, gap detection, and recursive querying to help users find or upload missing images until the objectives are met. Prior art does not focus on decomposition of image into entities, objects, backdrop, social interaction, body language, gesture, facial expression and so on and so forth. Further, missing images, nudges or prompts to user are not proposed in prior art. To put it simply an Natural language query such as: “Tomorrow is Adam's first day after recovery from injury” might result in mostly various injury related images of Adam, possibly taken at the treatment center, just prior to or after treatment, with his family, friends and visiting doctors/attending nurses etc. It will not however be possible for the prior art to discover what might Adam want to do post recovery? and then list those possible objectives and arrive at corresponding milestones and then arrive at reference images or corresponding descriptions which represent each successive stage/milestone/objective and then look for such images and then provide nudges for missing images. For instance the prior art will not be able to provide a relevant missing image nudge to user such as “where is Adam's picture where he is working hard on recovery along with a physiotherapist?” This nudge may correspond to a milestone such as “Being able to walk inside premises”, or “Being able to stand for longer time”, as such milestones are defined and laid out by the therapist. The prior art will also be not able to recognize what kind of progressions such as circular, alternating or one way non-cyclical, that may be existent, within progressive stages leading to a given milestone. For instance, the prior art will not be able to recognize cyclical and alternating hand and leg movements during a recovery exercise as prescribed by physiotherapist and use them to find such images if such were taken. Prior art will not be able to further arrange as per corresponding progression with nudge generation for missing ones.

Overall, while both referenced prior arts demonstrate some advancement in automated image selection and curation, they inadequately address the comprehensive tracking of milestones or the assessment of image match or fit to a milestone or stages leading to milestone, concerning narrative progression, as illustrated in the FIG. 1. The current systems miss critical functionalities, in sorting and ranking images by relevance, detecting gaps in sequences, and utilizing recursive querying methods. This impacts the ability to provide effective nudges and recommendations to users, hindering the completion and fulfilment of narrative objectives.

Therefore, there is a need for a system that classifies and organizes images based on a recognition and analysis of given subject's or object's objectives either of which, form the context, and corresponding organization and recommendations in the form of nudges based on the extent of such objective's fulfillment.

For organizing, categorizing, and retrieving images based on their content, context, and user-defined goals and milestones, with a focus on creating personalized visual narratives and recommendations, while effectively managing the progression of stages, and generating timely and relevant nudges for missing images along such progression, thereby enriching the user's storytelling journey. The nudges are expected to guide users in capturing appropriate images by identifying missing or incomplete stages, milestones or objectives thereof, as to which images might fulfill or fill in the gaps of such stages/milestones/objectives.

### OBJECT OF THE INVENTION

The principal object of the invention is to provide a context based image classification, organization and retrieval system based on given subject's or object's objectives that understands and categorizes images based on emotional, behavioral, dimensional and contextual cues related to user-defined goals and milestones or inferred goals and milestones of a given subject's or object's.

Another object of the invention is to identify subject's or user's goals and objectives by relevant information regarding significant life events such as professional achievements or personal achievements to understand context and objectives.

Another object of the invention is to identify an object's goals and objectives by relevant information regarding significant life change events associated with it, to understand context and objectives.

Yet another objective is to generate progressive milestones by creating a timeline of key milestones that represent significant achievements or goals throughout the subject's or object's journey towards respective milestones for a given objective for a given context, aligning with the context of the event.

Yet another objective of the invention is to analyze and decompose images by breaking down images into specific aspects, such as entities such as people and objects, interactions between person and objects such as but not limited to holding, lifting, touching or kissing medals/trophies, facial expressions, social interactions such as but not limited to handshake, namaste, wave, hi-fives, embrace, hug, body language, attire, and location, physical dimensions in case of object, to ensure images align with the subject's or object's milestones and objectives.

Yet another objective of the invention is to search for relevant visual representations by using advanced querying to identify images that match the representative example image for respective stages, milestones, objectives respectively, with aspect values that vary according to the stages, milestones, and objectives respectively, for a context, refining the search based on subject or user preferences and exclusions.

Yet another objective of the invention is to track and evaluate stage wise and milestone wise progression by continuously monitoring and evaluating based on aspect values for best match against corresponding representation for a given stage within a given milestone, within a given objective, for the concerned context, ensuring milestones are reached progressively as planned and adjusting the process when needed.

Yet another objective of the invention is to provide feedback and nudges for missing images by offering suggestions or prompts to guide users in locating or uploading images that fill gaps in their visual narrative, ensuring a complete representation of the journey.

Another objective of the invention is to provide the organized visual content by categorizing and displaying images based on milestone stages, ensuring the visual narrative accurately reflects the subject's or object's progression and achievements.

Yet another objective of the invention is to continuously track ranking and placement of images, allowing the process to evolve recursively as the user's or subject's or object's goals and contexts change.

Yet another objective of the invention is to recognize the person-person or person-object interaction and the object's dimensions themselves as either non-cyclic, cyclic or alternating states, and use as yet another way to find missing images that may have captured either of these state transitions.

These and other objects and characteristics of the present invention will become apparent from the further disclosure to be made in the detailed description given below.

### SUMMARY OF THE INVENTION

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

One aspect of the present invention is to provide the context-aware image organization and retrieval system that includes a user interface, context recognizer, milestone generator, aspect recognizer, state and state transition recognizer in entity or object and their interactions thereof, aspect library component, visual analysis component, query generator, text filter, text classifier, query processing unit, image description builder, image and search recognizer, score calculator, image presentation system, nudge/prompter module, and a zoom-in/zoom-out module.

Yet another aspect of the present invention is to provide user interface (UI) that prompts users to input person or object (for whom images need to be searched, classified, and organized), goals, milestones, and event contexts, allowing seamless image organization, search, and progress visualization along objectives, milestones and stages leading to them per aspect as per aspect framework, across devices, with nudges for capturing additional content.

Another aspect of the invention is to provide a context recognizer that analyses images to interpret goals and milestones using visual cues (e.g., attire, location, facial expressions, body language in case of subject or various types of dimensions that can be measured in case of object), ensuring accurate categorization and progression tracking.

Another aspect of the invention is to incorporate a milestone generator that identifies and suggests milestones based on user's or subject's or object's objective, while an aspect library and recognizer categorize images by attire, body language, facial expressions, social (person-person) interactions, person-object interactions and situational context for a given subject, by dimensions such as but not limited to count, length, breadth, height, angle of incline, diameter, concentration such as given count divided by given area for a given object, ensuring meaningful representation of user's, or subject's or object's experiences which are not merely grouped or clustered around a location, or timeline, or a person/s or an object/s, or tags, but rather based on what accomplishment and/or preparation for that accomplishment, or alternatively what damage and corresponding recovery as another form of accomplishment, and/or preparation for that accomplishment any given image represents.

Yet another aspect of the present invention is to provide an advanced query generation and text filtering systems that refine search results to match milestones and contexts, while a text classifier organizes keywords related to stages, milestones, goals or objectives, interactions, expressions, and progress for accurate image retrieval. Search results are expected to be refined by explicitly stating values and meta data for each of the covered aspects such as location, attire, facial expressions, body language, person-person interaction and/or person-object interaction in case of subject and various dimension types such as but not limited to count, length, breadth, height, angle of incline, diameter, concentration such as given count divided by given area, in case of an object. Either a text mining approach can be used or an entity decomposition approach can be used.

Yet another aspect of the invention is to incorporate a visual analysis component that evaluates images based on key aspects (e.g., expressions, body language, location, attire, social interactions, interactions with object) for subject, and key dimensions for an object, ensuring alignment with milestones and a score calculator that ranks images by relevance, and an image presentation system organizes them accordingly. Aspect specific progression is expected to be retrieved from the Aspect library component. Alignment with milestones as stated above can be determined by computing distance between representational image at each stage or milestone for each of the covered aspects. A given aspect is represented as the distribution of values across given dimensions. This is compared using distance formula between representational and given image to know fitment.

Another aspect of the present invention is to incorporate a nudge/prompter module for real-time suggestions and a zoom-in/zoom-out functionality to examine progress at various levels.

Another aspect of the present invention is to integrate a recursive querying mechanism that presents original images alongside similar ones and analyse moments leading to milestones and other way round, helping the user compare a subject's or object's goals and accomplishments.

Another aspect of the invention provides a process for classifying and recommending images based on a subject's or user's or object's goals or objectives related to significant life events, which includes: prompting for user objectives; receiving contextual input to identify specific goals and milestones generating progressive milestones analysing event aspects including but not limited to location, body language, social interactions with other entities, interactions with objects, attire and expressions for a subject; various dimension types such as but not limited to count, length, breadth, height, angle of incline, diameter, concentration such as given count divided by given area for an object, decomposing images into detailed aspects such as entities (person/s, robots, pets), objects, location, body language/pose, expressions, attire, social interactions (person to person) and person to object/pet/robot interactions for deeper analysis including:
1. state transition aspect as in-cyclical, non cyclical or alternating
2. value for the given aspect such as location name, attire type/desc, facial expression desc, body language/pose desc, motion desc, interaction desc and intensity. object dimensions such as count, length, breadth, height, angle of incline, diameter, concentration such as given count divided by given area;
generating specific queries and filtering these queries; classifying keywords into categories;
processing queries to build image descriptions; recognizing the progression of aspects; generating image descriptions that align with milestones; searching for images matching these descriptions using image recognition; employing recursive querying to find related visuals; detecting progression patterns in milestones; scoring and sorting images for relevance; presenting organized images; generating nudges to help identify missing image/s; enabling zoom-in and zoom-out functionality to provide either finer details into progression of aspect per stage per milestone or coarser details into progression of aspect, where incremental progress is skipped for showcasing major stage or milestone accomplishments; providing user feedback on image placement; repeating the process for additional milestones or contexts; and stopping the system when no further milestones are required.

These together with other objects of the invention, along with the various features of novelty which characterize the invention, are pointed out with particularity in the disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

The foregoing and other features of embodiments will become more apparent from the following detailed description of embodiments when read in conjunction with the accompanying drawings. In the drawings, like reference numerals refer to like elements.

In the following description, for the purposes of explanation, numerous specific details are set forth to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form to avoid unnecessarily obscuring the embodiments of the invention.

FIG. 1 depicts how a fit likelihood score will be stored for a given image for a set of aspects for a set of milestones. 101 “Object1 . . . m: {Aspect 1: value, Aspect N: value}” depicts the structure of an object or entity with a collection of aspects and corresponding values. 102 “milestone #1: (0,1) milestone #N:(0,1)”, depicts an example set of milestones leading to a given objective. 103”.

FIG. 2 and FIG. 2A showing components of backdrop separation and attire recognition in foreground which can be achieved through known machine learning algorithms to generate queries for image search and fitment. 201 “**Gaussian Mixture-based Background/Foreground Segmentation Algorithm alternatively MOG2” depicts choice of one possible algorithm for separating background and foreground from a given image. 202 and 205 depicts step “Extract” 203 “How did you drive to this location?” depicts a prompt to the user. 204 “Expected Dress Code”, depicts expected value of aspect “Attire”, 2A01 “Feature #1:10010, Feature #3:10010, Feature #7:1110001” depicts multi-dimensional embeddings for a constituent object or entity of a given image. 2A02 “Feature Selection by Importance” depicts optimum feature selection by computing influence or importance metric. 2A03 depicts one type of machine learning algorithm “Convolutional Neural Network” to learn the features for recognition. 2A04 “Scaling” and 2A05 “Transformation” depict step of feature engineering as a part of optimization of machine learning process.

FIG. 3 depicts an illustration of granularity of stages to zoom in or zoom out on progression to reduce the number of searches and sequencing.

FIGS. 3 & 4 depicting zoom in and zoom out feature with respect to progression in aspect showing fine grain and coarse grain control on search, filtering, and sequencing.

FIG. 5 illustrates the user interaction through user interface, wherein the user uploads an image and selects Subject or Person and provides Context. 501 “User Selects Photo”, 502 depicts “Accept Input for given Subject OR Object→Determine Intent”, 503 depicts “Autonomously determine Subject or Object”, 504 and 505 depict “Optional Additional Processing such as contour formation, classification, overlap removal etc.”, 506 depicts “Optional Additional Input for Context”, 507 depicts “Voice, Visual, Gesture”, 508 “Context Selected/Determined→Graduation” depicts selected or inferred context, 509 “Further Deconstruct Subject/Object and Surroundings”, depicts deconstruction step to separate foreground and background and entity and objects, 510 “Visit Aspect library to get various Aspects for Subject/Object”, depicts a step to retrieve aspects to be inquired about.

FIG. 6 depicts a facial analysis process where neural networks analyze an image of a “face” to identify or classify facial features and expressions respectively.

FIG. 7 illustrates the system where backdrop recognition, expression identification and attire detection ML models identify the subject's backdrop, emotional state, and attire resp., prompting the user for confirmation before generating a detailed description of the subject's appearance and context. 701 “Any available Generative AI Tooling” illustrates flexibility in terms of use of tooling. 702 depicts step “Analyze Attire”, 703 depicts step “Analyze Backdrop”, 704 “Tie”, depicts part of Aspect “Attire”, 705 “Shirt”, depicts part of “Attire” aspect as, 706 “Color→Navy Blue” depicts attribute “Color” and its value respectively. 707 “In absence of Context, Provide Prompt”, depicts programmatic instruction.

FIG. 8 illustrates the aspect library that includes multiple aspect details.

FIGS. 9 & 9A illustrates the generation of targeted search queries related to specific achievements, organizing the context for clearer query output. This is a framework for recursively arriving at prerequisite milestones and stages leading to them and generating corresponding queries for each stage/milestone as per another framework outlined in FIG. 37, for Generative AI tooling. 901 depicts “Context”. 902 depicts “Recognition of Accomplishment”, 903 depicts “Conditional Upon”, 904 depicts “Acts/Actions”, 905 depicts “Verification of Acts/Actions”, 906 depicts “Corresponding Moments”, 907 depicts “Photos/Images that needs to be looked up as per the moments”, 908 depicts “Generate Query”, 909 depicts “Completing Degree/Diploma”, 910 “Achieving Satisfactory Grades”, 911 “Project Completion”, 912 “Completing Curriculum”, 913 depicts “Congratulations Note”, 914 depicts a generated search query built using concatenation using this framework approach, “Find the moment you had received”+913+ “Regarding”+AND/OR (910, 911, 912)”. 9A01 depicts “Context→Graduation”, 9A02, 9A03, 9A04 collectively represent key moments to discover and inquire about. 9A02 depicts “Receiving Degree/Diploma Moment”, 9A03 depicts “Examination Participation Moments”, and 9A04 depicts “Completing Curriculum moment”. X→9A02 . . . N represents operation of retrieving aspects associated with discovered moments. 9A21, 9A022, 9A023 collectively represent Aspects chosen to inquire about at the given moment depicted by 9A02. 9A021 depicts “Facial Expressions”, 9A022 depicts “Attire”, 9A023 depicts “Social Body Language”, 9A0211, 9A0212, 9A0213 collectively represent the subsequent queries on each of these aspects. 9A0211 “What are typical Facial Expressions when posing for . . . ”, 9A0212 “What is the typical Attire when . . . ”, 9A0213 “What is the typical Social Body Language when . . . ”.

FIG. 10 illustrates an example of how generative ai tooling can be used to generate query response in CSV format, detailing structured entries for body poses suitable for photography based on filtering criteria.

FIG. 11 illustrates an example of how generative ai tooling can be used to generate query response in CSV format, for populating the social interactions between 1 or more subjects in a photograph and further how variations according to context can be generated.

FIG. 12 illustrates an example of how generative ai tooling can be used to generate query response in CSV format for populating the object-person interaction between 1 or more subjects and a given object or one or more such objects in a photograph.

FIG. 13 illustrates the process of using Generative AI and text filters to identify and describe expected attires for subjects in photographs as per various occasions, highlighting the structured response format for attire attributes.

FIG. 14 depicting fit likelihood results using 2 methods namely Text description based, and entity object decomposition based respectively. 1401 depicts applicability to Subject or Object. “*erson or Object to be used. Applies to both. With corresponding aspects”. 1402 “<attire desc> AND/OR <expression description> AND/OR <gesture description> AND/OR . . . ” depicts aspect value based filtering or search criteria. 1403 “Crowdsourced tags/labels OR Programmatically produced description” depicts how image labels irrespective of the source can be used for aspect based search queries. 1404 “Object: {Aspect 1: value,Aspect N: value}” depicts object representation of a given entity/person to be searched for based on a given set of aspects and their respective values. 1405 “Meta Data: {Aspect 1: value,Aspect N: value}” depicts metadata representation of a given entity/person to be searched for based on a given set of aspects and their respective values. (1408, and 1409 respectively for Object and corresponding Metadata) 1406 “For each aspect such as expression, gesture, movement, pose, position, and social interactions→describe→Intensity, Velocity, Vigor, and any additional attributes as applicable”, provides an example of Metadata that can be captured and used as additional criteria for search. 1407 “Pre-trained embeddings 1. Sentiment Intensity, 2. Pattern Matching, and more such known mechanisms” lists possible ways of representing entity/object data, encoding of so such as vectorized embeddings for aspect values and sentiment encoding for facial expressions, discovery of patterns in aspect values such as that of Attire, or for background/foreground discovery and use of all of these as match criteria in searching. 1408 “Reference Representational Object: {Aspect 1: value, Aspect N: value}” depicts object representation of a given entity/person to be searched for based on a given set of aspects and their respective values. 1409 “Reference Representational Meta Data: {Aspect 1: value,Aspect N: value}” depicts metadata representation respectively as fit criteria against any given entity/object (represented by 1404 and 1405 collectively) at each stage/milestone/objective respectively. 1410 “Match Presence/Absence, Match Magnitude, Match Metadata” describe match results as to whether given object matches reference representational object, whether given aspect is present/absent, whether corresponding aspect value matches in magnitude, and whether corresponding metadata object also matches in aspect and value respectively. 1411 depict “Fit Verdict based on 1410 for a given entity/object #1”. 1412 depict “Fit Verdict based on 1410 for a given entity/object #N”. 1413 depicts a given entity with constituent objects. “Person {Face, Body}” 1414 depicts Face entity with constituent objects “Face{Features[1 . . . N]” 1415 depicts feature entity with its constituent objects” Feature {Expressions[1 . . . N]}} 1416 depicts step of matching against “Match against” 1417 depicts Body object with constituent objects “Body {Attire,Pose,Shoulders,Arms,Hands,Feet}”, 1418-1422 depict detection steps for each of the constituent objects in 1417. 1418 depicts Hands as an object with constituent objects “Hands{Social_Interactions[1 . . . N]}, 1419 depicts step of aspect detection namely “Detect Attire”, 1420 depicts step of aspect detection namely “Detect Pose”, 1421 depicts step of object recognition namely “Detect Hands” 1422 depicts step of object detection namely “Detect Arms” depicts

FIG. 15 illustrates the process of context recognition, milestone generation, with breakdown of tasks.

FIG. 16 illustrates another variant where a grouping of certain aspects (1602) as required for social interactions (1601) is depicted, with optionally the cyclic, non-cyclic state transition for this group, in relativity to stationary aspects (1603). 16A01 “{Aspect #3, Stage #1}→“Seated”, 16A02 “{Stationary Aspect #1, Stage #1}→on Dias”, 16A03 “{Stationary Aspect #2, Stage #1}→“In Wedding Attire”, 16A04 “{Social Interaction Aspect #2, Stage #1}→Dear Ones”, 16A05 “{Aspect #3, Stage #2}→Stand up”, 16A06 “{Aspect #3, Stage #3}→Depart”, 16A07 “{Stationary Aspect #1, Stage #2}→Reception Hall”, 16A08 “{Stationary Aspect #2, Stage #2}→Casual Wear”, 16A09 “{Aspect #3, Stage #4}→Move”, 16A10 “{Stationary Aspect #1, Stage #3}→Ballroom”, 16A11 “{Social Interaction Aspect #2, Stage #2}→Dance”, all of these depict Aspect value corresponding to the given stage. 16A13 (“Acknowledges at”), 16A14 “Stands up”, 16A15 “Shakes Hands”, respectively depict the cyclical state transitions in aspect “Social Interaction” involving gestures such as “Gaze” (16A22), “Pose” (16A26) and “Hand” (16A27) respectively, of a Subject or Object of Interest. (16A21), 16A16 “Seated at Dias” depicts stationary aspect of “Pose” and “Location”. 16A17 depicts “Wearing Ceremonial Attire”, 16A18 depicts “Stage 1 . . . L” for each aspect, 16A19 depicts “Choreograph the Sequence of Actions Among Aspects”, which is how each aspect goes through state transitions as corresponding stages/milestones/objectives are accomplished. (as depicted in example 16A01→16A05), 16A12, “Repeat for {acquaintances, near and dear ones, friends etc.}”, depicts repeating discovery of “Social Interaction” Aspect's transition when interacting with others from social network, Registry list etc (16A12).

FIG. 17 illustrates yet another variant where expected stationary and non-stationary aspects are elaborated upon and further the state transitions within nonstationary aspects, and the corresponding missing image nudges the user. 1701 “Stands up”, 1702 “Shakes Hands”, and 1703 “Acknowledges” together represent cyclical state transitions that a Subject of Interest goes through. 1704 depicts a corresponding missing image prompt to the user or Subject of Interest “Hey you had a good time meeting X, and Y. Did you also meet Z? Was s/he there on that special day?”. 1708 depicts a corresponding missing image prompt to the user or Subject of Interest “Anyone else with whom you danced?”. 1705 “Walk”, 1706 “Take Hands”, 1707 “Dance” represent another set of cyclical state transactions that a Subject of Interest goes through. 1709 “Reception Hall-Dias” and 1710 “Ballroom #1” represent the location aspect of images. 1711 depicts the transition of a given stationary aspect of “Physical Location” from 1709 to 1710. 1712 depicts a corresponding missing image prompt to the user or Subject of Interest “Who helped you transition so quickly?” 1713 depicts a missing image prompt to the user or Subject of Interest “How about an attire transition picture?” concerning transition of stationary aspect “Attire”. 1714 depicts yet another missing prompt to the user of Subject of Interest “Who helped you fix that hat or gown?” concerning preparatory stages leading to Attire transition and corresponding Social Interaction aspect.

FIG. 18 illustrates the attire repository within the aspect library. This is one embodiment of how a given aspect such as attire can be identified using aspect recognizer and looked up from the existing labeled repositories.

FIG. 19 illustrates the dynamic weighting of different aspects when analyzing progress toward a milestone, showing how aspects are adjusted based on specific context. The cuboid represents a simple visual illustration of 3 aspects being weighted simultaneously, while the wheels cuboid stands on are stationary aspects (timeline and attire respectively) at least for the given milestone. “1|0” represent whether the person is “at” expected location, and “within” given timeline.

FIG. 20 depicting how for each aspect noncyclic (2006), cyclic (2007) and alternating (2008) state transitions will be stored as vectorized embeddings (2002) for comparison purposes. Nested Scope for vectorizing, embedding and storage (2001) for a given aspect is represented by Objectives 1 . . . N (2005), corresponding Milestones 1 . . . N (2004), and corresponding Stages 1 . . . N (2003) respectively.

FIG. 21 showing progression of one specific aspect such as social interaction along milestones and comparison of given image with representative image at milestone to determine fit. 2101 depicts “Extraction of vector representation of Social Interaction Gesture from Reference Image representing Stage N”, 2102 depicts “Extraction of vector representation of Social Interaction Gesture from Image representing Stage N−1”, 2103 depicts “Extraction of vector representation of Social Interaction Gesture from Image representing Stage N−2”, 2104 depicts abstract step of “Extraction vector representation of Social Interaction Gesture from Given Image”, which in turn gets applied to each stage as in 2101, 2102, and 2103 respectively. 2105 depicts an example of Distribution Match Aspect wise, where Changing Aspects are represented by Body Gesture as Shaking Hands, and Stationary Aspect is represented by Attire as Suit, Another Stationary Aspect: Body Posture: Standing, Yet another Stationary Aspect: Object in hand: Suitcase”.

FIG. 22 illustrates the process by which the aspect recognizer identifies and categorizes clothing items and their placements on the human body for improved context understanding. 2201 and 2213 depicts “Tie”, 2202 depicts “Coat”, 2203 depicts “Shirt→Half Sleeve”, 2204 depicts “Shirt→Full Sleeve”, 2205 depicts “Skirt”, 2206 depicts “Pant Suit”, 2207 depicts “Socks/Leggings”, 2208 depicts “Shoes”, 2209 depicts “Trousers”, 2210 depicts “Skirt/Frock”, 2211 depicts “Pants→Half Pants”, 2212 “Shirts→T-Shirt”.

FIG. 23 depicts one possible approach of sequencing images based on recognizing non-cyclical, cyclic and alternating state transitions in one or more aspects. 2301 depicts “Possibility 1: Cycling State Transitions for a given aspect”. 2302 depicts “{1 . . . R} where R is number of aspects per image” 2303 depicts “Possibility 2: Alternating State Transitions”. 2303 depicts “Possibility 3: Unidirectionally Progressive and Non Cyclic”. 2304 depicts “Step 1. Identify aspects that need to undergo cycling state transitions”. 2305 depicts “Step 2. Identify aspects that need to undergo alternating state transitions”. 2306 depicts “Step 3. Identify aspects that are unidirectionally progressive” 2308 depicts “Given Stage”, 2309 depicts “Given Milestone”, 2310 depicts “Given Objective”, each depicting the scopes wherein the steps need to be repeated.

FIG. 24 depicting two examples of detecting missing images through recognition of non-cyclical, cyclical, and alternating state transitions. 2401 “Recommended Representative Food Images”, depicts images for comparison purposes at each of the cyclical states represented by mealtypes in turn represented by 2403 (“Breakfast”), 2404 (“Lunch”). 2405 (“Dinner”), 2402 “For each day in {Day 1, . . . , Day N}” depicts comparing mealtypes contained in images, temporally. 2406 “Images taken of food consumed” depicts collection grouped by mealtypes as state transition criterion, laid out temporally as a progressive, non-cyclical state transition. 2407 “For mealType in Types:” depicts iterating over cyclical and alternating state transitions.

FIG. 25 depicts an illustration of how state transitions are used to sequence images and generate missing nudges. 2501 “Decomposition” depicts deconstruction of govern image into constituents. 2515 and 2516 respectively depict constituent objects post decomposition. 2502 “Breakfast Platter #Served” depicts state transitions around consuming food. 2503 “Compare” depicts comparing a given image with a representative reference image. 2504 “Served” and 2505 “Finished” depict state transitions. 2506. “Images taken on #/Day 7” depicts a subset of images on a given day. 2507, “Breakfast Platter #Finished”. 2508 “Hey, It seems you added Breakfast Served but forgot to add breakfast finished image on day 7th”, depicts a missing image prompt (2520) based on mealtype, state transition and temporal aspect. 2514 “Similarly for other stages such as lunch and dinner” depicts how missing images containing other mealtypes can be prompted to user. 2509 and 2510 represent outputs post application of match criteria 2519 “AND (object Match 1, object Match 2, . . . , object Match N)”, 2517 and 2518 respectively show verdict of match criteria application. 2511, 2512 respectively represent start and end of the timeline for temporally arranged images. 2513 represents reducing scope via filtering images based on a specific timeline, 2521 depicts contextual objective of image sequencing. “Objective→Adherence to Diet Plan” 2522 “Milestones→ {Served, Finished.} on Day X” depicts corresponding milestones to be reached through achieving requisite state transitions on a daily basis per meal type. 2523 “Cyclical Stages→{Breakfast, Lunch, Dinner}”.

FIG. 26 depicts an illustration of how alternating state transitions are used to sequence images and generate missing nudges. 2601 “{Consumption}” represents a progressive, non-cyclical state. 2603 represents justification for selection which is that Food/resources once consumed cannot revert to previous state. 2602 “{Day 1, Day 2, Day N}”. depicts another example of progressive, non-cyclical state transition. 2604 “MealType: {Breakfast, Lunch, Dinner}” depicts a mixed example of progressive (when considered within a given day) and, cyclical (when meal types are considered across days), example of state transition. 2605 “Consumption: {Served,Finished)” represents cyclical when taken across a given progressive such as day, and alternating example of state transition when considered per meal type. 2606 represents the temporal aspect “Time of Day: {Morning, Afternoon, Evening)”, as another example of mixed progressive and cyclical state transition. 2607 “Non Cyclical” depicts a filtering criterion whereas 2610 “Filter on Day” depicts an image filter using time/Day. 2608 “Progressive State within” represents second level of filtering using 2611 “Filter on Mealtype—timeofDay”, 2609 “Filter on consumption” represents third level of filtering 2613 “Day 1 . . . N” and 2615 “Any given Day X”, illustrates scope restriction for searching images. 2614 represents further image selection based on mealtype such as “Breakfast OR Lunch OR Dinner” Images. 2616 “Iteration #1 Morning”, 2617 “Iteration #2 Afternoon” depict time based correlation of mealtypes for temporal filtering as an alternative to that based on mealtype. 2618 “Breakfast Served and Finished Images”, further illustrate a specific mealtype selection and within that the alternating state selection of 2619 “Served” or 2620 “Finished”.

FIG. 27 illustrates the significance of attire in relation to various occasions, depicting appropriate clothing choices (2701 “Expected Dress Code”) for each identified event. This is expected to be learnt (either through classification algorithms (or by processing responses to generative ai tooling) and a repository with event-appropriate attire association is created. 2702 “Women: {dress Type #1 . . . N} Men: {dress Type #1 . . . N}” depicts pre-existing class or segment specific attire choices.

FIG. 28 illustrates a state transition diagram demonstrating the progression of various aspects (facial expression, attire, etc.) of a student's journey towards achieving a graduation milestone.

FIG. 29 showing the successive progression of one or more aspects such as location, body position or pose and attire respectively and missing nudges to the user. 2901 depicts query “Search for <y> <posing> in <indian ethnic apparel> for <temple> visit at a <store>” inquiring into Pose aspect for given Subject of Interest, putting in condition about whereabouts. 2902 depicts query “Search for <y> <posing> in <indian ethnic apparel> for <temple> visit <don't care/any> location prior to visit”, relaxing condition on whereabouts. 2903 depicts “Stop At the Apparel Store” as a progressive milestone towards Objective of “Dressing up for the Occasion” in terms of aspect “Attire” for Subject of Interest. 2904 depicts “At the walkway just before entrance” as a retrospective stage from the milestone of “Reaching the Apparel Store”. 2905 depicts correlation aspect change in value for Aspect “Body Language or Pose” with respect to another aspect of “Location”. 2906 depicts the value of the “Attire” aspect as “Ethnic-Indian Wear” as a subcategory of 2907 “Ethnic Wear” 2908 “Extracted Background” depicts extracted background, from step of foreground and background separation from a given image. 2909 depicts change in aspect “Physical Location” value based on time. 2910 depicts selection or time based filtering criteria as “When Match==T”, 2911 “Begin exploring prep stages” depicts retrospective exploration of preparatory steps or stages from a given stage or milestone for a given aspect. 2912 depicts a missing image prompt “Any pic of someone helping you in aligning properly?” 2913 depicts a missing image prompt “Any pic of someone helping you in adjusting properly?”, and 2914 yet another missing image prompt “Any pic someone helping you in tying properly?” 2926 “Steps where assistance may be needed in wearing?” depicts a query (2927), to a platform (2928) for a discovered aspect Attire value of “Worn Ethnic Wear” (2929) in given image. searching for “Social Interaction” aspect in retrospective preparatory steps for a given milestone of “Dressing up for the occasion”. 2915 (“Ethnic-IndianWear”, 2916 (“EthnicWear”), 2917 (“OtherEthnic-Wear”), 2919 (“Western T-Shirt”), 2920 (“ChineseShirt”), respectively represent apparel categories/subcategories for aspect of “Attire”. 2918 (“Decompose until first match”) depicts the recursive decomposition process of a given entity component such as 2921 (“Bust”) to detect the closest match for apparel type. (2915-2917) and similarly for 2922 (“Headgear”) to detect the closest match for headgear worn as among 2923 (“Cap”), 2924 (“Scarf”), and 2925 (“Hat”).

FIG. 30 illustrates how all the conceptual understanding about aspect progression along a given stage/milestone/objective framework and state transition thereof in the aspect value can be applied to organize images within a given context. 3001 depicts “Walking in or stepping in” as a progressive step in aspect “Physical Motion”. 3002 depicts “Walking out or stepping out as a progressive (3004) complimenting step in aspect “Physical Motion”. 3003 depicts “Entity: {Car, Store, N}”. 3004 represents the Axis of progression in aspect of “Physical Motion” such as reaching entrance (3006) an apparel store (3005) for trying on dresses. 3007 represents yardstick expressed in terms of Location reached at given time t. 3008-3010 represent such progression in aspect of physical location for Subject of Interest. 3008 depicts “Subject of Interest “Walking In” to the apparel store. 3009 depicts the complimenting state of 3008, which is “Walking out of the apparel store”. 3010 depicts “walking in/out of the car in front of the temple” as complimenting states concerning the Subject of Interest and given Object (Transport vehicle in this example). 3011 depicts person of interest. 3011-3013 represent progressive steps in aspect “Attire” of the Subject of Interest. 3011 being “Trying Attire” and 3012 being “Seeking Assistance in Wearing” for aspect “Social Interaction” of Subject of Interest, and 3013 being “Adjusting Before Posing” as progressive steps towards achieving the desired milestone of “Dressed for Occasion” or “Ready to Pose”.

FIG. 31 illustrates how search queries can be generated to find missing images, organize them according to aspect wise progression and state transition, or if not found then generate missing image nudges for the user. 3101 illustrates “Stages leading to Pose for the Occasion”, describes progressive stages towards attaining expected Pose as value of aspect “Body Language”. 3102 illustrates “Collect Alternating/Cycling/Complimenting States of given aspect while all others being stationary/Same” command issued to search and collect states associated with a beginning (3103) and similarly for conclusion (3104) of a cycle. 3103-3108 depict queries for cyclical/alternating/complimenting states for aspect “Physical Motion”. 3103 depicts a query for “Searched for image when you “Walk into the apparel store”, 3104 depicts query “Searched for image when you Walked out of the apparel store”. 3105 depicts another example of query concerning aspect of “Physical Motion” concerning entity of a transport vehicle, “Searched for image when you Walked into <transport>(car)” and 3106 depicts query “Searched for image when you Walked out of <transport>(car)”. 3107 depicts a query for aspect “Physical Motion” concerning an entity of Temple “Searched for image when you <Walked in> the <Temple>” and 3108 “Searched for image when you <Walked out> of the <Temple>”. 3109 depicts a query to search for the preparatory stage for aspect “Attire” “Searched for image when you Tried <Ethnic Indian Attire>”. 3110 depicts the query “Searched for image when you Sought Assistance in wearing <Ethnic Indian Attire> regarding search for aspect of “Social Interaction” in preparatory stage of aspect “Attire”. 3111 depicts the query “Searched for image just before posing” regarding aspect of “Body Language/Pose”. 3112 depicts missing image prompt “Any pics taken of you walking out? In your New Attire?” regarding the aspect of “Physical Motion” that compliments another state of “Walking in” to the Subject of Interest with a specific state of “Attire” aspect. 3113 and 3119 depict “Reference Generated Image” for comparison purposes at a given stage/milestone for a given aspect. 3114-3116 represent progressive steps in the milestone of “Posing before camera”. 3114 being “Stage−1: Seeking Assistance” the Social interaction aspect, 3115 being “Stage 0: Wearing/Trying Attire”, the Attire aspect, 3116 being “Stage 1: Agreeing to Pose/Posing before Camera”, the Body Language aspect. 3117 illustrates the missing image prompt “Any pics taken of you stepping inside the car? concerning aspect of “Physical Motion” complimenting the state of “Stepping outside” associated with Entity (Person)-Object (Transport Vehicle) interaction. 3118 illustrates the missing image prompt “Any pics taken of you stepping outside the car? concerning aspect of “Physical Motion” complimenting the state of “Stepping in” associated with Entity (Person)-Object (Transport Vehicle) interaction.

FIG. 32 illustrating a synthesized representation of images based on discovery of successive progression of aspects through stages and milestones. 3201 illustrates Novel approach in capturing a “successive progression” along discovered milestones/stages. 3202 depicts possibilities with more aspects such as Social Interaction, Facial Expressions, Person-Object interactions, 3203 states a synthesized summary of Person of Interest's visit during a given time interval. 3204 depicts a Person of Interest “Walking into the store” describing Physical Motion aspect, 3205 & 3213 depict Person of Interest “Changed appropriately” describing Attire/Dressing Aspect and Walked out describing Physical Motion Aspect, 3206 illustrates “Got assisted by best friend” describing “Social Interaction” aspect. 3207 illustrates “Adjusted your dress Prior to Pose” describing Attire/Dressing aspect. 3208 illustrates “Posed” describing aspect “Body Language”, 3209 illustrates “Stepped out of Transport” describing aspect “Physical Movement”, 3210 illustrates “Stepped back into Transport” describing aspect “Physical Movement”. 3211 illustrates “Approaching the Venue”, describing aspect “Physical Movement”. 3212 illustrates “Departing from the Venue” describing aspect “Physical Movement”.

FIG. 33 illustrates a sequence built through a recursive process where a sequence of events is generated within a given context. 3314 represents the example context of “Graduation”. The context can be “user provided” (3312) or “derived from image” (3313). 3301 illustrates a query generator component for retrospective 3303 (“what precedes”) inquiry. 3302 represents the response from the query component. 3304 (“Course Completion”), 3305 (“Receiving Grade”), 3306 (“Taking Exam”), 3307 (“Attending Classes”), 3308 (“Registering for Classes”), 3309 (“Attending Orientation”), 3310 (“Visiting Campus”), illustrate successive stages or milestones discovered as response (3302) through “what precedes” (3303) query to query generator (3301). 3315 represents optional capstone project completion requirement as applicable in addition to previously discovered milestones/stages. 3320 represents “Verification” of completion of each stage/milestone discovered previously. 3318 and 3319 respectively represent the “moments” that were derived from description/image (“3313”), “1 . . . N” at each start, during or completion of each stage/milestone. For each such discovered moment (3316), query is expected to be built (3317), for suitable images to be found and sequenced accordingly.

FIG. 34 illustrates a structured format table to illustrate the changes in aspects such as a student's body language and associated cues as he approaches and receives their degree. Text description of image can be processed accordingly in lieu of or in addition to image decomposition method. 3401 illustrates one possible aspect progression such as Object of Interest's Placement. (Handing over of Degree/Diploma Certificate for instance). 3402, 3403, 3404, 3426, 3427 respectively illustrate journey/progression of Object, namely, “in the showcase”, “In the platter”, “Extended Towards”, “InthehandsofAwarder”, “InthehandsofAwardees”. 3406 (“Anxious”), 3407 (“Anticipating”), 3408 (“HeadInclined”), 3409 (“Tense”), 3410 (“Relieved”) respectively, illustrate successive progression of Facial Expression (3405) as an aspect for Person/Subject of Interest. 3412 (“Stood Up”), 3413 (“Walked to”), 3414 (“Stepped up”), 3415 (“Leaned Forward”) respectively, illustrate successive progression of aspect “Body Pose/Posture” of 3411. 3416 (“Confident”), 3417 (“Steady”), 3418 (“Upright”) respectively, illustrate successive progression of aspect “Body language”, 3420 (“In the building”), 3421 (“In the Corridor”), 3422 (“In the Hall”), 3423 (“On Stage”), 3424 (“Pause”), respectively illustrate successive progression of aspect “Physical Movement/Transit” (3419), 3429 (“Looked at”), 3430 (“Nodded”), 3431 (“Extended Hand”), illustrate successive progression of aspect “Social Interaction” (3428).

FIG. 35 illustrates the process of generating detailed search queries based on user-defined contexts and milestones, helping refine queries for image searches effectively.

FIG. 36 illustrates how a given image is compared aspect wise with representative images at each concerned state and milestone to decide best fit. 3601 depicts vector representation of aspects associated with an image. 3602 represents fuzzy likelihoods or odds of a given image belonging to a given stage based on representation of a given aspect. 3603 illustrates possible ways such as plotting silhouette charts, fuzzy clustering likelihoods, or computing wasserstein distance between representative and actual vector distributions, for estimating belonging to a given stage, milestone or objective.

FIG. 37 illustrates selection of one or more aspects from images for scoring of images based on a weighted analysis of such aspects.

FIG. 38 illustrates the analysis of multiple aspects related to a situation or event, Again the wheels indicate the stationary aspects (Attire and Time Range) at the given stage or milestone. A person can be dressed for the occasion or not. (Binary 1|0), Person can be at the location in time range or not (Binary 1|0).

FIG. 38A illustrates the process for determining the relative importance of various aspects in academic milestones, including graduation. 38A01 illustrates iterating over each progressive aspect as depicted in FIG. 34. 38A02 depicts Stage 1 . . . N Progression for a given aspect while iterating over all aspects. 38A03 illustrates an example of a query “What a student typically does socially?”, to generative AI platform, in Educational/Graduation/Receiving Degree Context, and focusing on social interaction aspect as depicted in 38A04 38A05 depicts an example of retrospective query keyword Visual Clues such as Facial Expressions Prior to an activity or event such as Receiving Degree or Grade. 38A06 illustrates one specific aspect such as Facial Expressions, to look op. 38A06 illustrates another aspect to be discovered about such as location or place through the query “Where does a student visit?” and 38A07 illustrates discovering aspect of “Physical Motion”. 38A09, 38A10, 38A11 respectively, illustrate exploring 3 distinct milestones namely Taking Exam, Receiving Grade, Course Completion in the journey of graduation. 38A12 illustrates the use of retrospective keyword such as “Prior” in querying 38A13 and 38A14 respectively illustrate attribution factors or weights allocation to aspects namely “Facial Expressions” (10%), and “Social Interactions” (30%) of a student as person of interest.

FIG. 39 with more cross-domain examples of possible state transition detection and depicting how a known machine learning algorithm can be used to predict the next state transition. 3901 illustrates states for persons of interest such as Coordinator/Host, states being: {Looks on, Shakes Hand, Embraces}. 3902 illustrates states for persons of interest such as a Player at a game/tournament, and states being: {Looks at Trophy, Lifts it, Kisses it, Leaves it back on the table}. 3903 illustrates states for persons of interest such as a Host for an event, and states being Host: {Recognizes, Hands over the Trophy or Award, Shakes Hands}. 3904 illustrates states for trainer such as Yoga instructor and states being Person: {Asana #1, Asana #2, Asana #3}, or {Pose #1, Pose #2, Pose #3}. 3905 states the process of training, fitting and evaluating machine learning models to predict the next state. 3906 lists one possible machine learning algorithm such as LSTM (Long Short Term Memory) for prediction. 3906. Predict Next State, Detect Anomalous states, Detect Absent/Skipped States. 3907 states expected function of machine learning algorithm which is to Predict Next State, Detect Anomalous states, and Detect Absent/Skipped States. 3908 illustrates examples of objects such as Race Car while racing: {Crossed Flag #1, Crossed Flag #2, Crossed Flag #3} OR Trophy in states of possession: {with Player #1, Player #N}: When players circulate Trophy among themselves or players after winning in cyclical states.

FIG. 40 illustrates alternating state transitions of image aspects and use of known machine learning algorithms such as Reinforcement Learning to predict the next state and use for filtering only a given state. 4001 depicts a state transition table to document all possible states such as depicted in 4006 {hold trophy, raise it, keep it down} for context of game celebration or as depicted in 4007 {sit, stand up, applause} or as depicted in 4008 {Clap, Fold}, when context is attending a concert or as depicted in 4009, {Anticipate, Celebrate} when context is turning points in sports match/game etc. and corresponding transitions from those states. 4002 declares rewards for the machine learning algorithm to learn for a state transition. 4003 illustrates actions that can be taken from each state to transition to the next state. 4004 illustrates tuning/altering awards in the Bellman equation so as to favor one transition over another. For instance, Reward recognizing Hold, or Stand or Clap, or Celebrate state over their corresponding flip states: for filtering/retrieving purposes. 4005 shows an example of this filtering such as “I just need players lifting the trophy but not keeping it down”, accomplished by adjusting rewards for state transition to control transition possibilities from a given state.

FIG. 41 illustrates the system's tracking of progress by identifying completed and missing progressive steps for each aspect such as missing locations within location aspect, dressing up or down sequences for the occasion within attire, missing progressive social interactions within given interaction such as handshake or embrace etc., detailing the breakdown of milestones and objectives per image aspect.

FIG. 42 illustrates how the nudge/prompter module prompts the user to add missing information or images identified within the milestones. The context in this illustration is Reaching a landmark agreement. 4201 depicts the prompt “You shaking hands with your counterpart is missing” to add missing images. 4202 illustrates the prompt for missing object-subject entity relationship pictures. “Your signing docket pic is missing”. 4203 illustrates the prompt such as “Your Exchange docket pic is missing” for a missing social interaction related to moments of concluding transaction. 4204 illustrates the missing moment of in progressive stage of signing accord in aspect of transit. “Arriving at Meeting Room”. 4205 further illustrates progression in social interaction gestures prior to signing. “Recognize→Smile→Wave”. 4206 illustrates further progression in social interaction gestures such as “Shake Hands→Embrace”. 4207 illustrates the concluding step in signing accords such as Exchange Dockets. 4208 illustrates progression in aspect of movement or transit such as Arriving at Venue. 4209 illustrates progression in aspect of object-entity interaction”. Take Docket from Aides” 4210 illustrates yet another progression in object-entity interaction such as “Open Docket→Write/Sign” towards the milestone of signing accord. 4211 illustrates further progression in signing accord in aspect of entity-object interaction such as “Close Docket.” 4212 illustrates progression in aspect of transit such as “Walk towards Seats”. 4213 illustrates progression in aspect of body posture such as “Become Seated”. 4214 illustrates progression in aspect of body posture such as “Stand up”.

FIG. 43 shows the system triggering objective completion recommendations for each context and milestone, suggesting missing images as milestones are progressively achieved. Context in this illustration is Graduation, example milestones leading to the objective of graduation are attending classes, visiting campus.

FIG. 44 illustrates the role of the nudge/prompter module in highlighting missing elements crucial for campaign success. (context in this illustration). 4401 depicts transition in attire aspect from Suit to Khadi (Attire #Type #1 to Attire #Type #2). 4402 depicts transition in aspect location from Home-to Party Office. 4403 depicts a social interaction aspect such as Greet. 4404 depicts another social interaction aspect such as Meet and Greet Supporters. 4405 depicts Progressive Stages of Advancement (stages can vary by Aspect). 4406 depicts missing notification of missing visual element concerning progression of attire aspect. “Seems your khadi picture is missing”. 4407 depicts notification for missing visual elements in aspect progression of travel or transit. “Seems your transit pictures from Residence to Party Office are missing.”. 4408 depicts another missing element notification concerning aspect of social interaction. “Seems your shake hands|embrace pictures are missing <optionally names retrieved from social networks/contact lists>”. 4409 depicts yet another missing element notification concerning aspect of location. “It seems your parliament speeches pictures are missing entirely”. 4410 refers to a gesture such as Recognize by a person of interest. 4411 refers to yet another gesture such as Embrace by a person of interest.

FIG. 45 illustrates a process for classifying and recommending images based on the analysis of a subject's goals and objectives.

FIG. 46A-E illustrates the process of classifying and recommending images based on analysis of an object of interest, wherein identification and quantification of objects of interest is shown in the context of histopathology, using various known algorithmic techniques. 46A01 depicts progressive stages as Stage 1 . . . N→Ratio of ImmunoPositive Vs ImmunoNegatives or Damaged/Good. 46A02 depicts the Otsu Method or U-Net Method of separating foreground and background. 46A03 depicts Build Initial Segmentation Mask and Distance Maps-Separating Nuclei from Rest. 46A04 depicts Respective Probabilities of a given Pixel belonging to C1, C2 outlined as px1:[p(C1),p(C2)] . . . pxN:[p(C1),p(C2)]. 46A05 depicts consideration whether pixel belongs within segment boundary or outside segment boundary. 46A06 depicts Classification algorithms such as SVM can be used to classify pixels into C1 or C2 segments. 46A07 depicts collecting all pixels that are most likely to be in C2 rather than C1. 46A08 depicts process step of Tuned Segmentation Mask Separating Nuclei from Rest. 46A09 depicts OpenCV-Watershed Algorithm implementation as one possible way for separating overlapping regions of interest. 46A10 [px1,pxm]→Calculated and Recalculated likelihoods respectively, post segmentation mask and overlap treatment of any given pixel belonging to C1, C2, 46A11 depicts final visual separation of Nuclei (Good or Bad yet unknown)

FIG. 46B illustrates the process of classifying and recommending images as depicted in 46B03, based on analysis of an object of interest, wherein generation of targeted search queries as depicted in 46B01, “What are the expected {immunopositive} nuclei per unit area arranged by {breast cancer stages} {filter on Ki-67}?” related to specific progression of a recognized dimensional aspect for an object of interest, organizing the context for clearer query output. It further illustrates an example of how generative ai tooling can be used to generate query response in CSV format, as depicted in 46B02, detailing structured entries with header column values as “Stage, Biomarker, Expected Immunopositive Range, Notes” and corresponding example row value as “Early-Stage (I & II), Ki-67,” 5%-25%”, “Per mm²; proliferation marker with given filter criteria for a specific biomarker in this instance.

FIG. 46C illustrates the process of classifying using a Neural Network trained on features such as Nuclei Morphology, shape, type, count and density respectively, as depicted in 46C02, and recommending images based on analysis of an object of interest, as depicted in 46C01 as nuclei good or bad and positive/negative marked objects of interest, as depicted in 46C04, wherein, how a given image for an object of interest, is compared aspect wise, as depicted in 46C05, where given aspect of Concentration value of ImmunoPositive per square MM is computed and compared with representative images at each concerned state and milestone to decide best fit as depicted in 46C06.

FIG. 46D illustrates the process of classifying and recommending images based on analysis of an object of interest, wherein, how the nudge/prompter module prompts the user to add missing information or images identified within the stage wise progression of a recognized aspect of concentration for the object of interest, immunopositive or negative nuclei in a tissue sample in this instance. The context in this illustration is Breast Cancer progression being the objects of interest.

FIG. 46E illustrates alternating state transitions of image aspects for objects of interest, in the context of breast cancer progression and recovery and use of known machine learning algorithms such as time series analysis or Long short term memory (LSTM), or transformers to detect alternating growth and shrinkage as depicted in 46E01 to predict the next state when the progressive trend and fluctuations into recovery/relapse as depicted in 4602, indicated by growth/shrinkage in tumor size is observed.

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiments of the invention.

### DETAILED DESCRIPTION OF THE INVENTION

The embodiments herein and the various features and advantageous details thereof are explained more fully with reference to the non-limiting embodiments that are illustrated in the accompanying drawings and/or detailed in the following description. Descriptions of well-known components and processing techniques are omitted to necessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

Reference in this specification to “one embodiment” or “an embodiment” means that a particular feature, structure, or characteristic described in connection with the embodiment is included in at least one embodiment of the present disclosure. The appearance of the phrase “in an embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon the present disclosure.

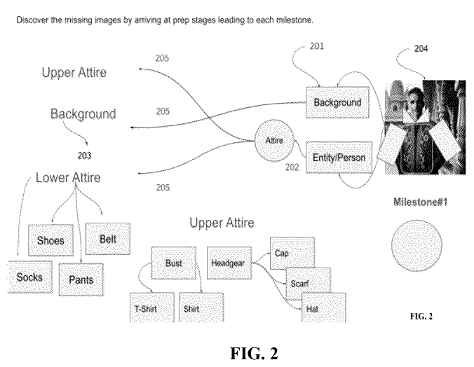

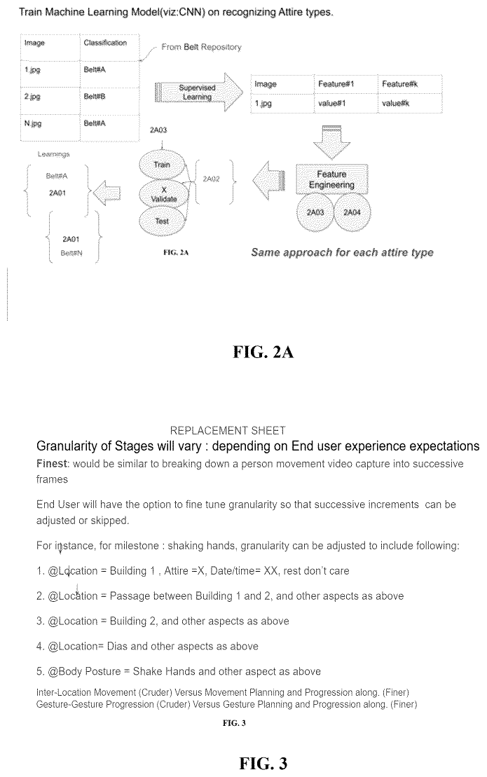

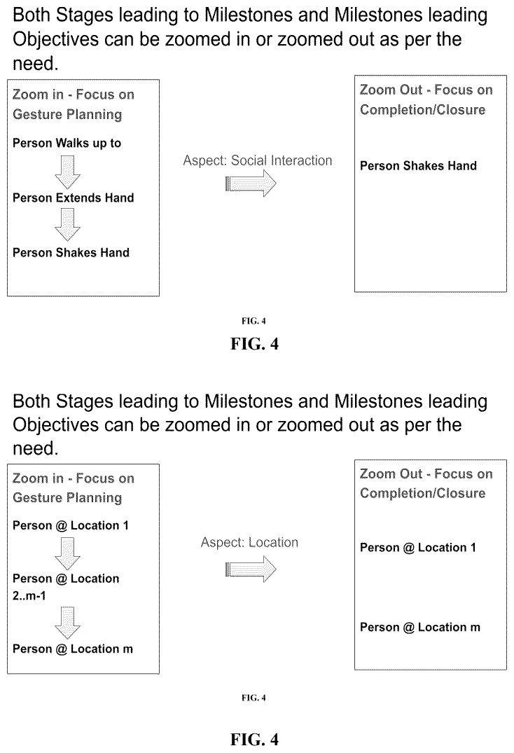

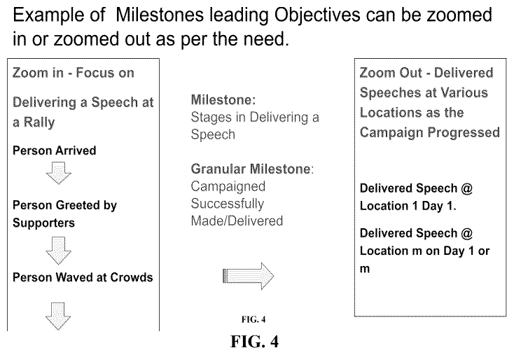

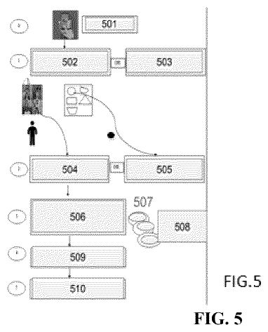

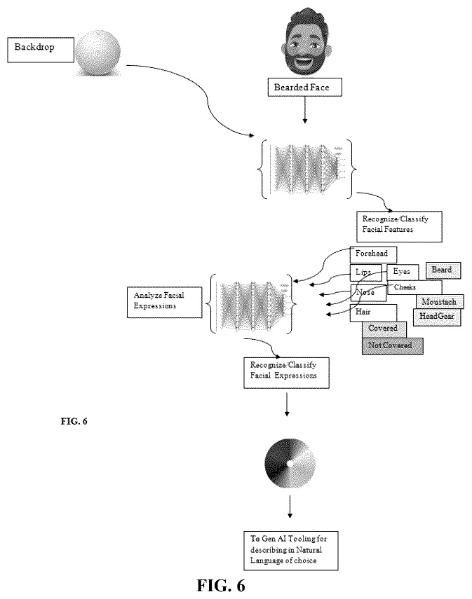

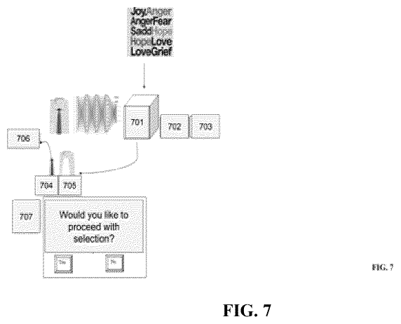

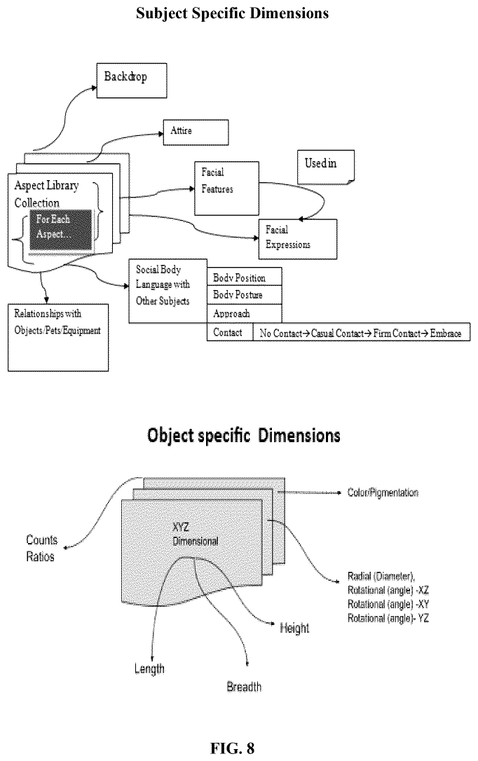

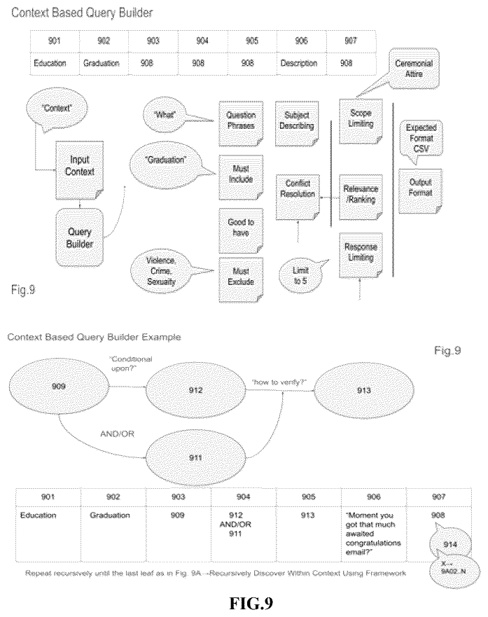

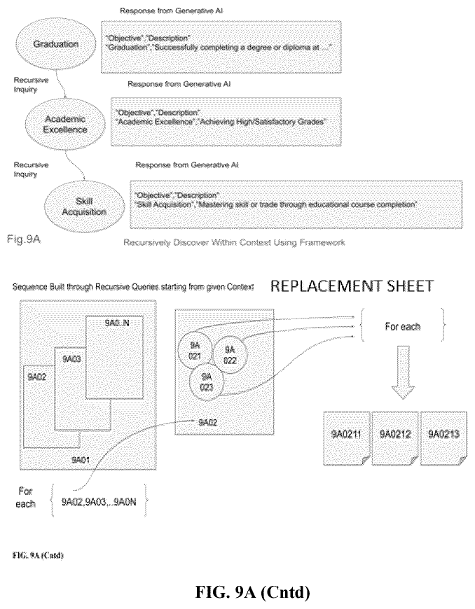

The present invention provides a context based image classification, organization and retrieval system to understand and categorize images based on a set of pre-defined or user specified aspects including but not limited to location, body language, facial expressions, attire, social interactions with other person/people, person-object interactions, various dimension types such as but not limited to count, length, breadth, height, angle of incline, diameter, concentration such as given count divided by given area in case of a user-identified object, and contextual cues related to user-defined goals and milestones. The system integrates known computer vision algorithms used for image decomposition and analysis, text-image and image-text algorithms and text processing algorithms with a framework where user specified or inferred objective, by making use of known generative ai algorithms, is decomposed into associated milestones and milestones in turn are further decomposed into progressive stages leading to such milestones, to dynamically generate visual journeys, identify missing images as per the progressive framework stated earlier, and as applied to aspects that are either user specified or which have been predefined or have been inferred, and provide nudges for missing images to help create a compelling narrative, as illustrated in the FIGS. 2 and 2a.

The context-aware image organization, retrieval and rendering system evaluates and categorizes images based on the goals and objectives of subjects including people, pets, and robots or equipment, and is implemented as a standalone application or on a cloud-based platform where users upload images for processing and organization. Additionally, it is integrated as extensions in photo rendering apps, including mobile devices, tablets, and wearable devices including smart lenses and glasses. This flexibility ensures that the system is utilized across various platforms, enhancing the user experience regardless of the device used.

In one embodiment, the context-aware image organization and retrieval and rendering system comprises a user interface, context recognizer, milestone generator, aspect recognizer, aspect library component, visual analysis component, query generator, text filter, text classifier, query processing unit, image description builder, image and search recognizer, score calculator, image presentation system, nudge/prompter module, and zoom-in/zoom-out module.

The user interface (UI) enhances user interaction by prompting them to input goals, milestones, and event contexts including but not limited to graduations, weddings, personal achievements, anniversary, birthday, celebration, passing an examination, award in competitive sports and the like (but not limited to) as illustrated in the FIGS. 3 and 4 and enlargement or contraction in various dimensions due to variety of potential root causes such as but not limited to quality degradation, wear and tear over time or due to operational stress or abuse in case of a non-bodily or external object, or due to disease/disorder in case of an bodily object, enabling context based image search and organization. It supports image uploads from devices, cloud services, or mobile/wearable devices and categorizes images by context, milestones, and progression stages, offering a clear visual representation of the user's journey. The UI includes efficient search functionality, including structured query generation, enabling the user to search and filter keywords or phrases describing aspects and their corresponding values and corresponding metadata, or images, and progress visualization tools including milestone tracking, and nudges to encourage users to capture missing images that complete the progression as per milestones and stages leading to milestones. It integrates multimedia elements, customization options, accessibility features, and a zoom-in/zoom-out module for detailed or aggregate viewing. The interface ensures seamless compatibility across various devices, allowing users to input, confirm, and adjust image contexts. Additionally, structural and content feedback guides users in organizing and positioning images effectively, ensuring a cohesive, intuitive, and meaningful visual narrative that accurately reflects their journey.

In an example embodiment, the UI allows the user to randomly select any photograph from gallery, prompts/allows the user to input subject information and intention, and accepts optional contextual inputs in voice, visual, or gesture form as illustrated in the FIG. 5. Alternatively, it can also infer the Subject from the image as illustrated in FIGS. 6 and 7.

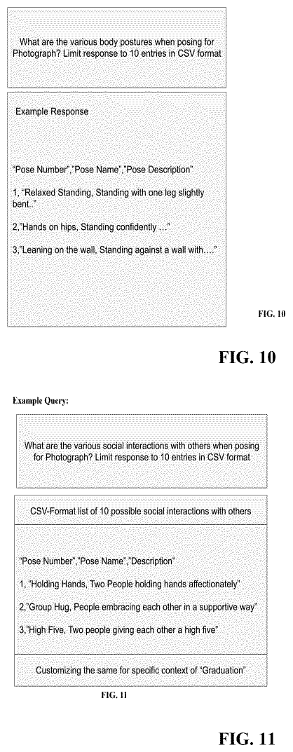

In another embodiment, the context recognizer analyses uploaded photographs to understand the intent of subjects or objects within the images. It identifies the subject's or object's goals through visual cues including facial expressions, body language, attire, backdrop, social expressions, objects held, and text displayed and through various measurable dimensions such as but not limited to count, length, breadth, height, angle of incline, diameter, concentration such as given count divided by given area, in case of an object. Alternatively, an object can be recognized as an external, non-bodily object or a bodily object including but not limited to an organ or tissue or cell or a microorganism. Advanced machine learning models utilizing computer vision techniques interpret these cues to accurately infer the subject's or object's intent. For instance, facial expressions can be encoded as per Facial Action Coding System, Convolutional Neural Networks and their adaptations such as Mask R-CNN can create pixel-level masks for each object. Body objects and regions such as those representing infections or disease advancement and cells of arbitrary shapes can be detected through commonly available algorithms such as R-CNN, Watershed, and U-Net. Hough Transform, Watershed segmentation, and Contour Detection can be used to detect round or overlapped shaped, or arbitrarily shaped objects respectively. It can be trained on commercial or open source or proprietary datasets that contain clothing labels (e.g., shirts, pants, dresses). Social Interactions can be detected by identifying various body poses or gestures through available tools but not limited to such as MediaPipe, OpenPose, and DensePose. Location change/progression can be detected by trajectory prediction algorithms such as but not limited to Social LSTM. Further text to image and image to text generator algorithms are already available such as but not limited to Parti/PartiPrompts by Google, and CM3leon by Meta for text to image generation. Deep Convolutional Networks, Variational Autoencoders, and Generative Adversarial Networks have been leveraged to synthesize images based on text description. Further foreground/background separator algorithms such as Gaussian Mixture-based or Mixture of Gaussians (MOG) are available. Additionally, the context recognizer assesses the broader context of the image, recognizing events or settings including weddings, graduations, holidays and the like. Using computer vision algorithms such as but not limited to Convolutional Neural Networks or Vision Transformers such as swin or DETR which are trained on open source or commercially available object databases such as but not limited to COCO, ImageNet, and COIL it detects objects, scenes, and events, cross-referencing this data with contextual cues like voice or text inputs by user through a user interface, location data, or calendar events. For instance, the context recognizer deconstructs the subject and surroundings in a photograph to analyse the visual cues, as illustrated in the FIG. 5, FIG. 6, FIG. 7 and FIG. 8. This comprehensive analysis allows the context recognizer to determine the specific context of each photograph. Once identified, the context is passed to a milestone generator as illustrated in FIG. 9, and aspect library as illustrated in FIG. 8, which generates relevant milestones and categorizes the image appropriately within its aspect progression as per the previously identified milestones and stages leading to milestones as illustrated in FIG. 9A. progression, which ensures each image is properly contextualized and placed in the correct stage of its narrative as per the respective progression of each of the covered aspects. An illustration of how each aspect is inquired about using generated queries fed to a third party or home-grown generative AI platform, is shown in FIG. 10 through 13.

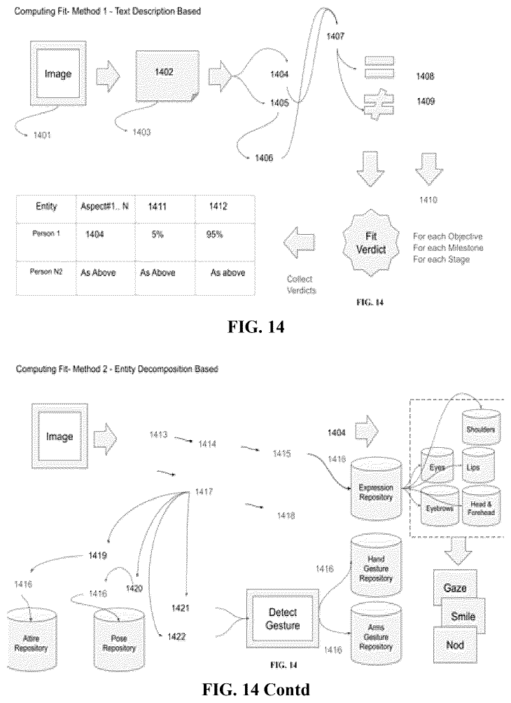

In another embodiment, the milestone generator identifies relevant milestones within the determined context, providing a structured framework for the user's journey. It retrieves predefined milestones associated with the identified context. The generator utilizes generative AI to suggest additional milestones based on the image content and context, ensuring a comprehensive representation of the user's experience, as illustrated in the FIG. 14. By breaking down the event into most significant milestones, the generator enhances the user experience, making it easier for users to document and celebrate their significant life events. It sends the identified milestones to the aspect library and query generator, for image organization and retrieval process.

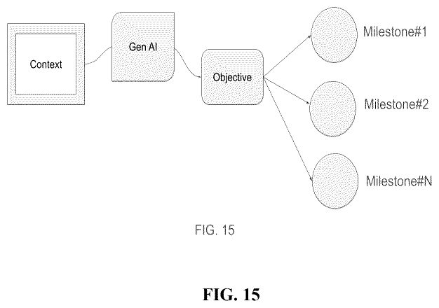

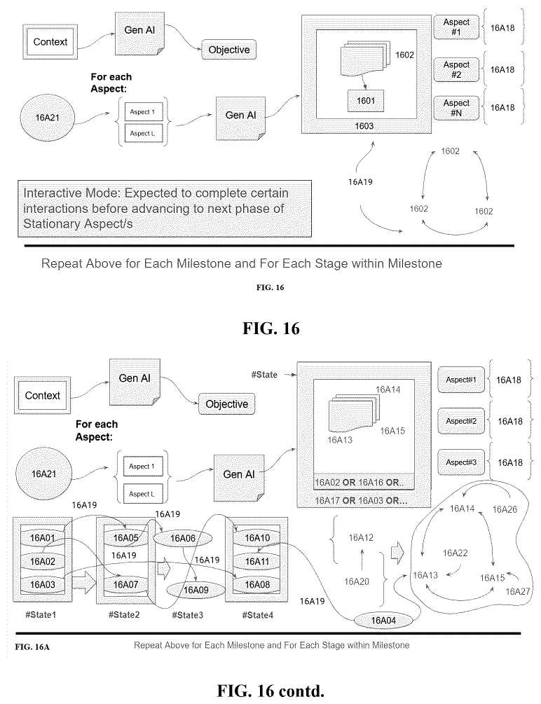

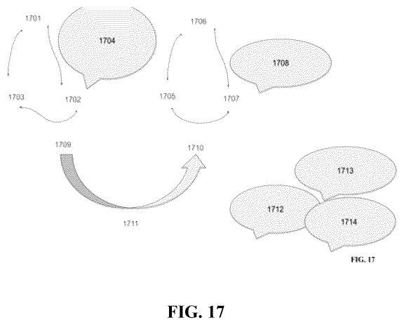

In an example embodiment, the context recognizer recognizes the context from the user input and feeds the context into the generative AI utilized by the milestone generator, to analyse the context and identify the key stages. It then breaks the stages into most significant tasks or milestones, each with specific criteria for success. The milestones are ordered logically, creating a clear roadmap to achieve the final objective, adjusting as needed, as illustrated in the FIG. 15, FIG. 16 and FIG. 17.

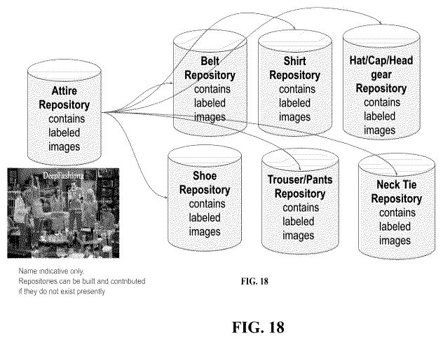

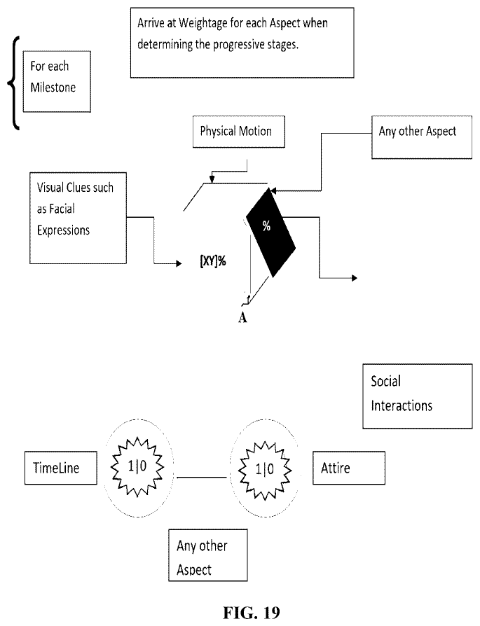

The aspect library is populated by generative AI and stores predefined frameworks that define the progressive stages for various aspects within a given context and milestone. These aspects include details with backdrop, location, facial features, facial expressions, body language, body position, body posture, approach, attire, social body language with other subjects, contact including no contact, casual contact, firm contact, embrace and other context-specific factors, as illustrated in FIG. 8 and FIG. 18. Each aspect is associated with specific progression stages, which are organized in a structured framework that enables the system to monitor how the user progresses over time. The aspect library also contains weighting values that define the importance of each aspect during various stages, allowing users to customize these weights to better reflect their priorities an illustration of how these weights attached to aspects is provided in FIG. 19, which provides users with the ability to tailor the system to match their personal experience, giving them control over how their journey is tracked.

For instance, after receiving the input for the context and deconstructing the subject and surroundings in a photograph, the system analyses the visual cues and gathers the aspects or details based on the subject from the aspect library as illustrated in the FIG. 5, FIG. 6, FIG. 7, and FIG. 8.

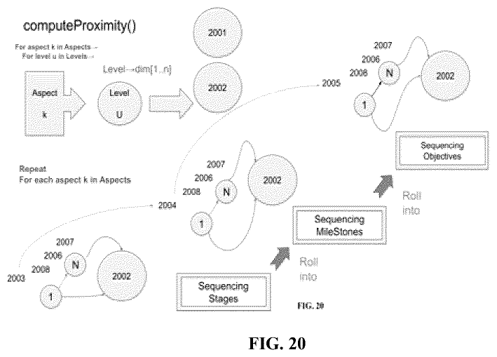

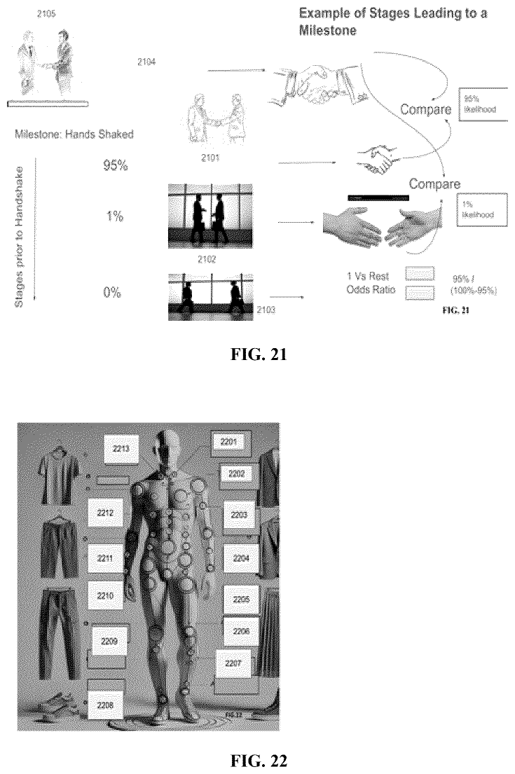

The aspect recognizer is responsible for deeply analysing the visual content of images to identify and extract detailed aspects that align with the identified milestones and stages. It examines various elements including facial expressions, body language, attire, setting, and context-specific features that are crucial for understanding the emotional and physical progress of the user's journey. For example, if the milestone is a graduation, the aspect recognizer will focus on detecting joyful facial expressions, formal attire like caps and gowns, and the appropriate setting, including a ceremony or reception. Additionally, the aspect recognizer detects and matches types of successive progression states, including cyclical/non-cyclical and alternating/non-alternating patterns in the milestones as illustrated in FIG. 20, which enhances the understanding of progression dynamics and ensures the correct representation of the journey's stages. The recognizer also breaks down images into smaller components, including entities (people, objects), posture, location, attire, and emotive expressions that represent the user's or subject's progression through the event. The aspect recognizer helps track how these visual cues evolve over time, contributing to the creation of a meaningful visual narrative. Through use of commonly available machine learning algorithms as mentioned in [0095] for image processing, it ensures that the images accurately represent the user's emotional and physical state at each stage, thereby creating an authentic and accurate depiction of milestones. An illustration is provided in FIG. 21.

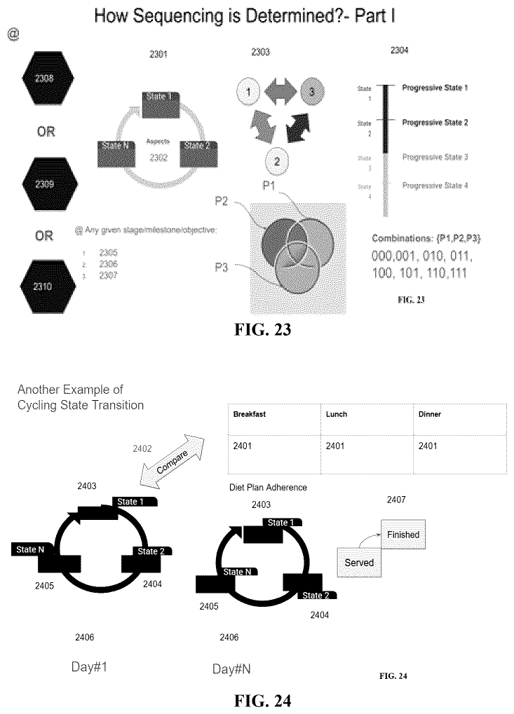

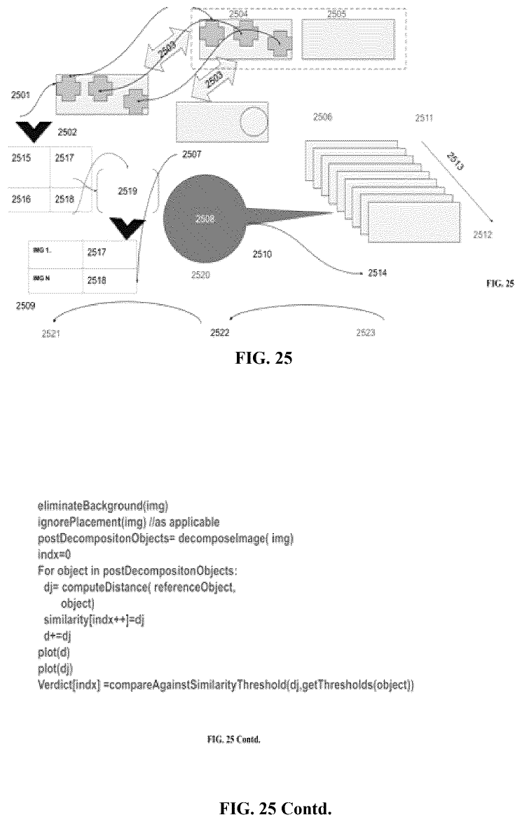

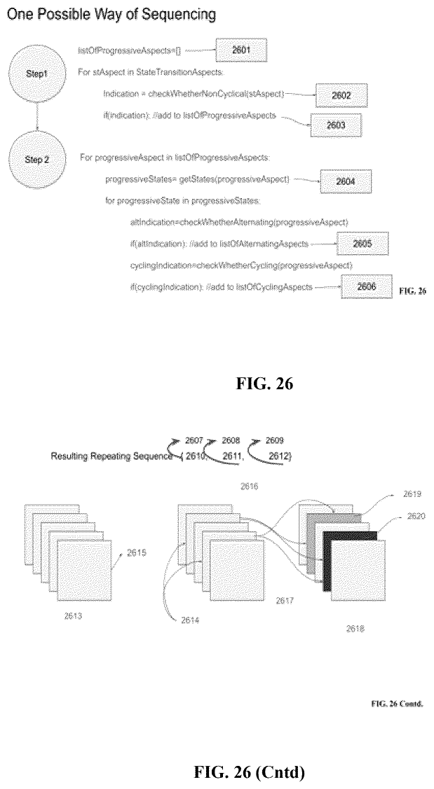

In an example embodiment, the aspect recognizer understands and categorizes the clothing items and placements on the human body, where it identifies and categorizes elements including the attire, body parts, and how they relate to each other, as illustrated in the FIG. 22. The other example processes are illustrated in FIGS. 23 through 26.

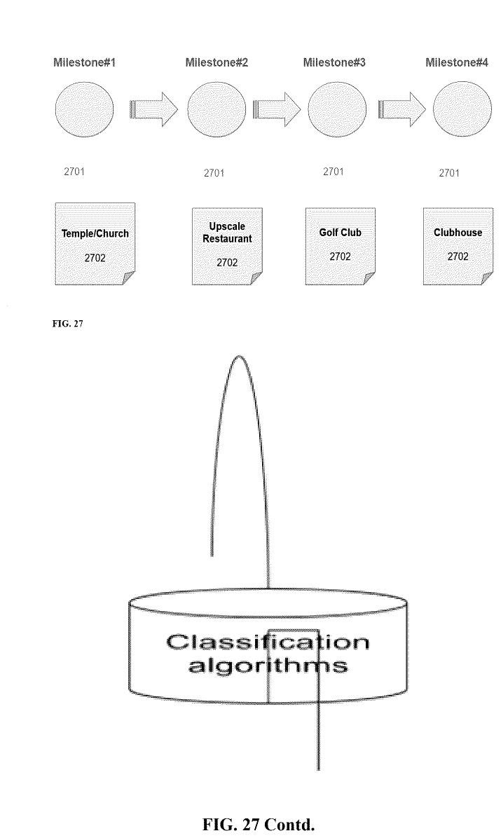

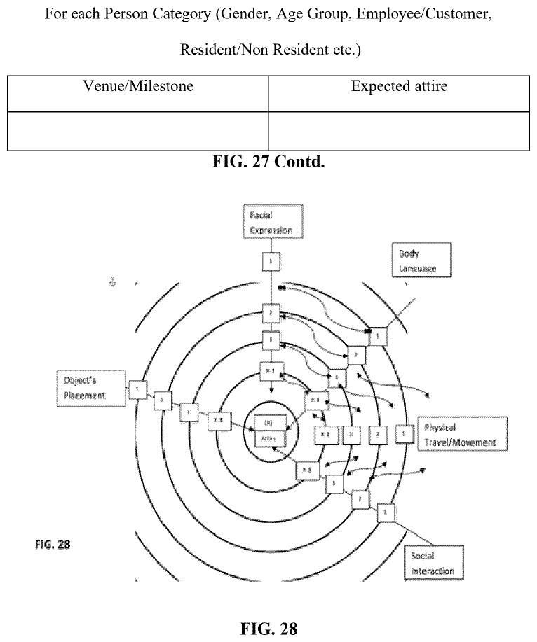

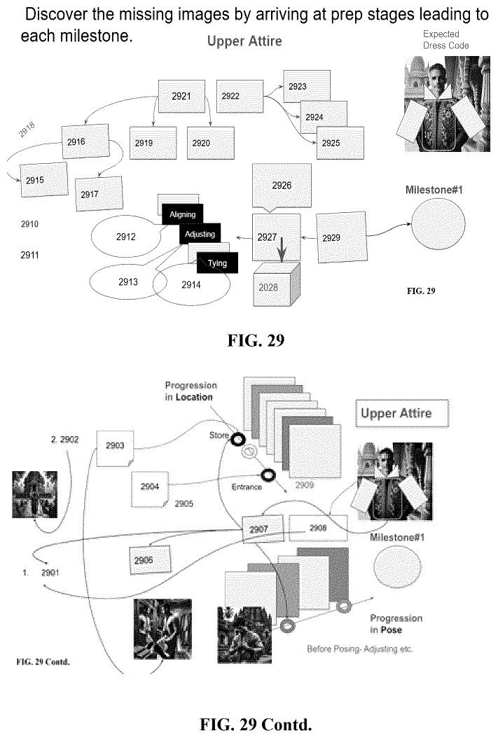

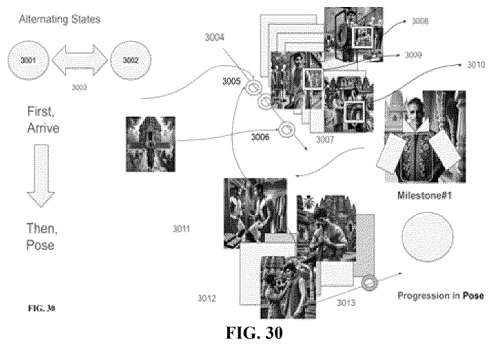

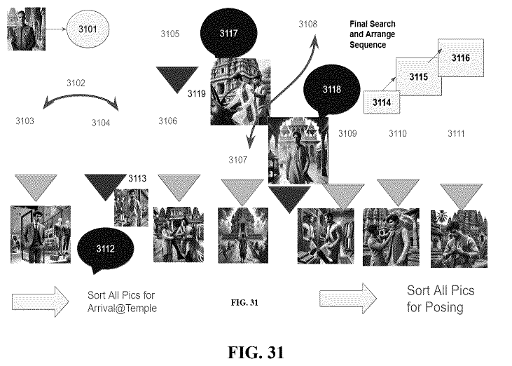

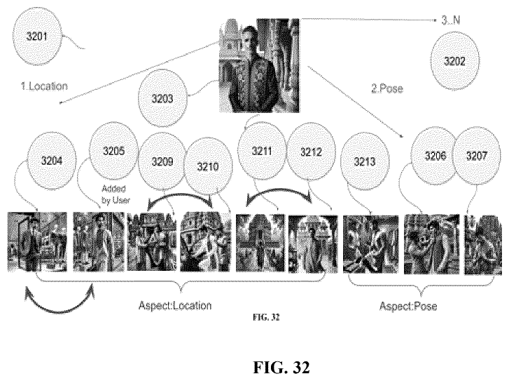

In another example embodiment, when the system receives the contextual input about the occasion, including a temple or church or visit to any public place of worship or gathering place, upscale restaurant, golf club, or other events. The context recognizer identifies the specific event and its significance. Once the context is identified, the milestone generator creates milestones, where each milestone represents a different event or occasion. For example, Milestone 1 could represent “Venue A,” Milestone 2 could represent “Venue B,” and so on. After determining the occasion, the aspect recognizer analyses the specific event's aspects that need to be represented, including attire, facial expressions, body language, social interactions, person-object interaction and location. It recognizes that attire is a principal element to match the occasion (e.g., attire lor attire 2 for a destination 1, attire 3 for a destination 2 and so on), as illustrated in the FIG. 27. In an example embodiment, FIG. 28 presents a state transition diagram that visually illustrates the progression of several aspects of a subject or situation over time as the subject moves closer to achieving a specific objective, such as where a student obtains a graduation degree. Key aspects contributing to this event include facial expression, body language, object placement (e.g., holding a diploma), attire (graduation gown), physical travel/movement (walking across the stage), and social interaction (shaking hands with the dean). Each aspect progresses through distinct states, labelled 1, 2, 3, X−1, (X), 8, representing a progression sequence or level of intensity. X−1 and (X) denote critical transition states. The figure visually demonstrates how these diverse aspects converge as the student approaches and achieves the objective. Lines connect the various states and aspects, visually leading towards the center, symbolizing this convergence, which indicates that the various aspects align and harmonize at the moment of degree conferral. The example process is illustrated in FIGS. 29 through 32.

The system emphasizes the importance of contextual image placement. Any image considered for inclusion in a visual representation of this event must be evaluated for its correct position within the sequence to minimize “deviational error”—the error caused by misplacement. The formula Min (SUM (DeviationError1 . . . N)) represents the system's goal of minimizing the total error across all images in the sequence. One likely implementation for evaluating deviation error is representing each aspect within a given image as a distribution and then computing the difference between the distributions (obtained by histogramming or by feature extraction) or between the embeddings obtained through deep learning such as through Vision Transformers, and then using a mathematical function such as Wasserstein Distance. The system searches for relevant photos across multiple media platforms, matching image descriptions or metadata to descriptions of the generated “moments” in the sequence. Furthermore, the system identifies not only the key “accomplishment” moments but also intermediate moments leading up to them, providing a more granular understanding of the process. For instance, between “Attending Classes” and “Taking Exam,” intermediate moments like “Studying” could be identified, which allows for a richer and more detailed representation of the event and its associated visual narrative.

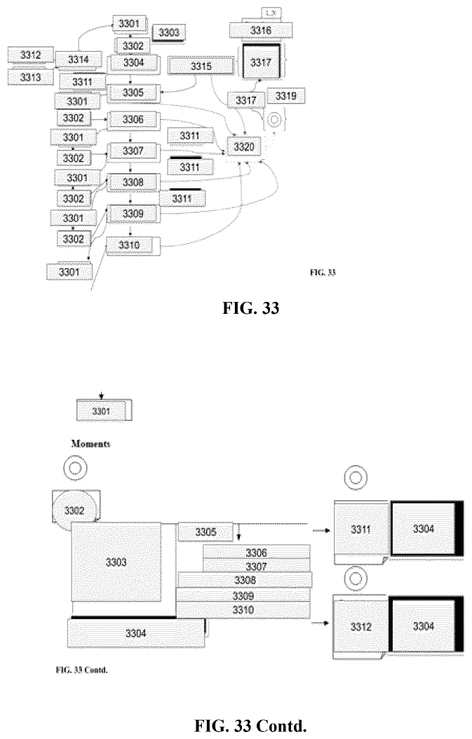

The visual analysis component works in tandem with the aspect recognizer to enhance the evaluation and interpretation of the visual content within images. It employs commonly available computer vision algorithms such as but not limited to Convolutional Neural Networks, Vision Transformers, and combination of the two wherein the former selects important features and latter uses those definitions to identify regions/detect objects and structural relationships between objects in a given image, Convolutional Block Attention based analysis where important regions and features are identified, to perform deep analyses, ensuring that the visual representation accurately reflects the expected milestones and stages of the user's journey. The representative images are generated using text to image generation algorithms as stated in [0087], as one possible mechanism for each of the stages leading to milestones and those leading to Objective. This process is illustrated in FIG. 33 where representative aspect descriptions at the milestones aka key moments in the visual journey, are inquired of using generative ai tooling. Further, FIGS. 9 and 9a The visual analysis component scans images for key visual elements including facial features, body posture, attire, and context-specific objects that are indicative of a particular milestone. Using techniques like facial recognition, pose estimation, and object detection, the system breaks down the image into its core components. For instance, it detects whether the user is gesturing a shake hand with the person giving the degree certificate, if their body language reflects the appropriate milestone (including detection of pose such as standing proudly at location of podium for fulfillment of objective as graduation), or if their attire corresponds to the expected stage such as attire of gown with hat. Once the analysis is complete, the visual data is sent to further processing units, including comparison with the representational image, which was generated earlier using a text classifier to detect desired aspect values (what should be the location at this milestone? what should be the attire at this milestone? and so on. Please refer to FIGS. 9 and 9a for illustration) and then fed to the text-to-image generator and corresponding score calculator. The collaborative process between the aspect recognizer and visual analysis component ensures that the system continuously recognizes what the representational images should be at each moment or milestone or stage leading to milestone and further searches for accurate, contextually relevant images that reflect the user's ongoing progression. Possible values and variations for each aspect are generated by querying available Generative AI or analysing a collection of stored images corresponding to each aspect, which allows the system to create a diverse set of possible expressions, postures, or visual variations based on structured responses obtained to queries posted to Generative AI tooling. Refer to FIGS. 10, 11 and 12 for illustration of queries posted to Generative AI tooling. These collections are then used to compare new images, assessing whether the goals are fully, partially, or not achieved. The query generator leverages this data to refine image search, delivering more targeted, goal-oriented content that accurately reflects the user's journey.

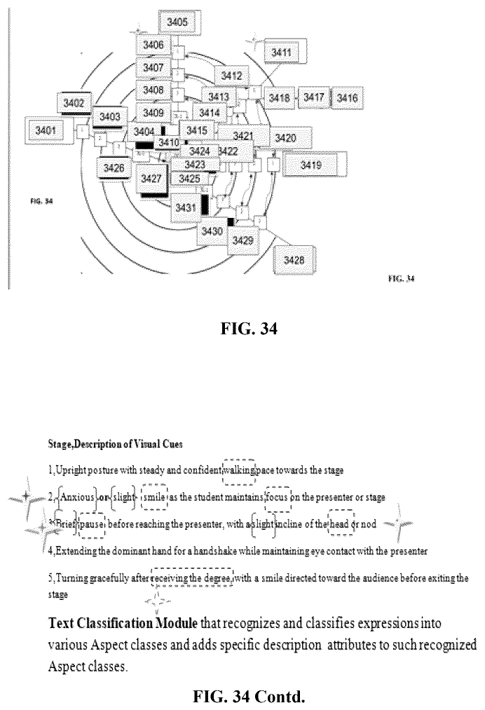

In another example embodiment, FIG. 34 includes the combination of state transition diagram and text classification to illustrate the progression of a student's body language and associated cues as they approach and receive their degree. The state transition diagram (top portion) visually maps the changes in the aspects associated with this journey during this process. It focuses on various aspects, including facial expression, body language, person-person interaction such as placement of degree in the hand of awardee by awarder, and person-object interaction such as lifting up the degree or holding it, further, more aspects such as attire, physical movement, and social interaction. The diagram shows how these elements evolve over time, progressing through numbered states (1, 2, 3, X−1, X), which represent sequential stages or levels of intensity. For example, facial expressions transition from “Anxious” (1) to “Relieved” (X−1), while body language progresses from “Stood Up” to “Leaned Forward” (X−1). These states converge visually, symbolizing the culmination of the student's journey as they receive their degree. The structured-table (bottom portion) offers a detailed, narrative description of these stages. Each stage corresponds to specific visual cues, including the student standing up, walking up to toward the stage, pauses before reaching closer to awarder, displaying anxiety early on, showing anticipation, and then tension, extending the dominant hand and then offering a handshake, and finally relieved turning to face the audience with a smile before exiting the stage. The table adds depth to the diagram by explaining these transitions in more tangible terms. Together, the diagram and table provide a comprehensive breakdown of the student's experience, useful for studying human behaviour, training AI models to recognize similar stages, or analysing specific social contexts like graduations.

In one example embodiment, FIG. 9 depicts an AI-powered facial analysis process, where the input is an image of a “person” against a “Backdrop”. Here, two neural networks analyse this image. One network focuses on feature recognition, identifying and categorizing facial components, including forehead, lips, eyes, beard, nose, cheeks, hair, moustache, and headgear (classified as covered or not). The second network analyses the facial expression. There are many known algorithm implementations to detect faces such as but not limited to EigenFaces and FisherFaces, and further Convolutional Neural Networks trained on a variety of emotion analysis databases such as AffectNet, Ascertain, FER-2013, Google's Facial Expression Comparison, can be deployed to analyze emotions on detected faces. Additionally, Bi-directional LSTM can also be deployed to further process the feature vectors learnt by Convolutional Neural Networks. Both face detection and expression analyses converge, wherein one type of analysis detects faces and another detects emotion types and each feeds into generative AI that generates a natural language description of the face, including its features and the detected expression. The system transforms visual facial data into a human-understandable textual representation, highlighting the AI's capacity to interpret and articulate complex visual information.

In another example embodiment, the aspect recognizer and visual analysis component analysing the moments leading to the accomplishment of objectives, identifying intermediate stages, and examining physical motion, body poses, and facial expressions for emotional shifts as illustrated in the Table 1.

TABLE 1

| About to Achieve | Achieved |
|---|---|
| In terms of Motion | From About to Achieve to Achieved |
| In terms of Emotive Expression | From About to Achieve to Achieved |
| In terms of Body | From About to Achieve to Achieved |
| Pose/Language/Gesture | |
| In terms of Attire/Dressing | From About to Achieve to Achieved |
| In terms of Social Interactions | From About to Achieve to Achieved |

The system breaks down progressions into distinct stages representing the flow of an action or journey, including “about to start,” “started,” “midway,” “about to reach,” and “reached.” So, the abstract terms “about to achieve and achieved” in table 1 depicted above would become so, i.e. from “about to start”, . . . until “reached”. A specific instance of progression in location as one aspect is as follows:
Rackham Building→Crisler Center→Crisler Center→Entry Gate→Lower level Corridor→Descending into Hallway→Main arena of Crisler Center→Central State→Exit from Main Gates.

Another example of how Framework for bodily expression or a facial expression is as follows based on the principles of reciprocity. Plan-Initiate-Await Reciprocations-Establish. Plan for instance includes,
1. Gesture
2. Body Language
3. Motion

Applicable for Eye Contact, Handshake, Hug or Embrace, Gestures using Fingers/hands. format is→ {data} {meta-data}. On a structured response obtained from Generative AI tooling, further Text filtering techniques can be applied such as by using regular expressions or other plurality of techniques to identify and filter out facial features followed by the {expression depicted.} followed by the intensity or peculiarity of expression when available.
1. Eyebrows {Raised}
2. Eyes {Widened}
3. Lips {Curved up} {Slightly}
4. Head {Nodding} {Gently} AND Head {Tilt} {Slightly}
5. Brows {Relaxed} {Position {{Neutral} OR {{Positive} {Slightly}}}
6. Eyes {Squint} {Slight}
7. Face {Relaxed} {Pleasant} {Agreeable}

Similarly, for body language and motion aspects, the following is an example of structured response obtained from Generative AI.
1. Posture {Upright}, Step {Focused}
2. Walk {Steady}, Arms {Relaxed} {at the sides}
3. Facial Expression-{Insert Variants here}: {Smile} {Slight}
4. Pause {Brief}
5. Gaze {Focused}
6. Hand {Extend}
7. Brows {Relaxed} {Position {{Neutral} OR {{Positive} {Slightly}}}
8. Eyes {Squint} {Slight}
9. Face {Relaxed} {Pleasant} {Agreeable}.

It also analyses emotive expressions by examining micro-moments in a process, like someone nodding to a proposal. Each moment is classified based on corresponding facial expressions, helping predict emotional responses and decision-making through subtle cues. For instance, recognizing stages in facial expressions, the system might list emotions like raised eyebrows, widened eyes, slight smiles, or head nodding. A text filter is used to identify specific expressions and their intensity, filtering out undesired ones (e.g., romantic gestures). The same approach applies to physical motion, body poses, and other bodily expressions. (as depicted above) This analysis helps understand the progression in each covered aspect such as location, attire, facial expressions, body language, interactions between people and objects respectively especially in decision-making moments, ensuring a nuanced recognition of the user's journey as it unfolded and advanced along various aspects as listed earlier. This paves way for intuitive nudges to user as to the how (transitions in aspects) and who (those who assisted or were present) along the progression.

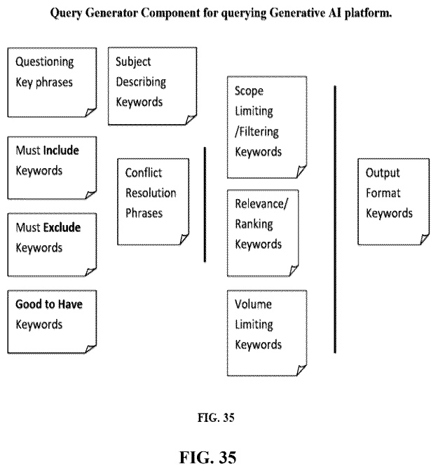

The query generator uses generative AI as one possible mechanism and is not restricted by such use, and is responsible for constructing detailed, descriptive search queries to locate relevant images that match the visual requirements for specific milestones within a given context. Alternatively, it receives inputs manually from the user, including the user selecting the phrases or keywords, or providing the visual, gesture, voice, or text input, wherein the AI receives key inputs with the context (including wedding, graduation, etc.), milestones (including “receiving the degree”, etc.), and obtains the aspect frameworks from the aspect library, which outline expected visual cues (including facial expressions, attire, etc.). It tries to retrieve what should be the attire, what should be the expression, what should be the place/backdrop, how should be the body language and posture, and so on).—for given context and within that context for respective milestones leading to goal achievement for given context. The query generator creates detailed search queries, again by using a framework as illustrated in FIG. 35, by combining various aspects. It includes the questioning key phrases including “Must Include” keywords (e.g., “formal attire,” “graduation ceremony”) to specify essential terms, “Must Exclude” keywords (e.g., “casual attire,” “half shirt”, “golf shirt”) to filter out unwanted elements, and “Good to Have” keywords (e.g., “outdoor venue”) for non-essential but desirable features. Additionally, it uses “Subject Describing” keywords (e.g., “poses,” “happily looking”,”) and applies conflict resolution phrases (e.g., “If attire is formal, exclude casual wear”, “if multiple matches for blue, then select Prussian blue). Scope-limiting (e.g. “within last one year”, “only for Subject A”, “only for those images containing Subject A and Object B”) relevance (e.g. context=“graduation”), and volume-limiting (e.g. “maxCount=10”) keywords refine the search, while output format keywords specify result formats (e.g., “CSV”), as illustrated in FIG. 10.

In one example embodiment, the FIG. 9 includes generating targeted search queries for visual content related to achievements within a specific context. The process begins with the “Context” input, which is entered into the system through the “Input Context” box. The query generator constructs the search queries based on the provided context. A table as illustrated in FIG. 9A is used to detail the context, including “Education” with the specific achievement being “Graduation.” The table organizes the query generation by utilizing a logical predecessor or re-requisite finding framework categorizing “Conditional on Acts,” “Acts,” “Verification of Acts,” and “Moments,” suggesting a structured approach to query creation. The goal is to find relevant photographs related to a given context such as “graduation”. It should be obvious to note that the framework can be used irrespective of the context. The “Feed Context to Query” step refines the search, while parameters like “Objective” and “Context” focus on educational content. Content is filtered by excluding inappropriate elements like “Sexuality, Violence, Crime,” and the “Expected format” is “CSV.” The system outputs the top 5 filtered search results in CSV format. The system referred to here can be a third party generative ai platform and associated tooling, or a home-grown system trained on various corpuses to process natural language queries.

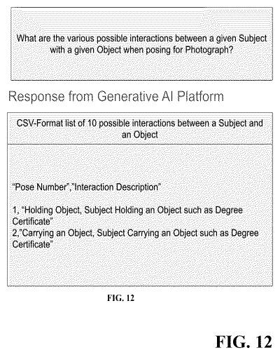

In an example embodiment, a programmatically generated query includes “What are the various body postures when posing for a photograph? Exclude any obscenities, nudity, sexuality suggestive, violent stuff. For additional filtering, apply PG guidelines for Motion Picture. Formal, or Casual or Sport attire are typically expected to be included. output should be in CSV format. Do not include tips. Limit response to 30 entries.” The query response for this query is illustrated in FIG. 10, wherein the response is in the CSV format limited to 30 entries, that provides a structured and detailed catalogue of body poses each with a brief description of pose suitable for photography, fulfilling the requirements and filters specified in the original query. Further examples for populating the social interactions variations between 1 or more subjects in a photograph and populating object-person interaction between 1 or more subjects and a given object or one or more such objects in a photograph is illustrated in FIGS. 11 and 12, respectively.

Once the queries are generated and refined, the text classifier recognizes and classifies expressions into various Aspect classes while adding specific descriptive attributes to each recognized class. The module analyses text input, extracting relevant keywords and classifying them into predefined categories including “goal or objective”, and “milestones” and “stages”. Keywords/phrases are attributed to milestones for a given context, then further they are mapped to the expected stage of advancement along each previously identified aspect. Example: Person wearing graduation gown. This is binary that is TRUE/FALSE (either the person is wearing a gown or not wearing a gown). Another example can be Person at location A then at B, leading to the final venue (such as when a procession advancing to the main venue is tracked). This is not binary but mapped to stage 1 . . . N. Another example can be a person arriving at the graduation hall. (Stage 1). a person was seated in a certain row. (Stage 2). person rose from the seat (stage 3), person headed towards the dias (stage 4), person felicitated (stage 5) etc. In summary, the mappings are as follows: 1. to context/milestone, 2. to aspect, 3. to stage of advancement within that aspect). keyword to context and milestone within that, and then action describing a keyword/phrase that is mapped to stages leading to a milestone. Further the keywords cover which specific aspect such as motion, body posture, facial expression, attire, social interaction, and gesture.

This classification ensures that the system accurately maps each keyword to the corresponding stages or aspects of a user's journey, making it easier to understand and process their narrative.

In one example embodiment, once the keywords are extracted and refined, the system categorizes them into emotion or progress aspects. In the context of “Recovery from Injury”, Keywords such as “resilience” or “strength” are classified under emotion, reflecting a user's emotional state, while terms like “first steps” or “rehabilitation progress” are categorized under progress, indicating stages leading to milestones or achievements in a specific journey. This classification is crucial for the system's ability to understand the context and align it with visual representations, including images that correspond to specific emotional or goal-related stages in the journey. The module's ability to classify keywords into these categories ensures that the system selects the most relevant content, whether it be for images, text-based narratives, or further context. This structured approach allows the system to organize the search and selection of visuals more effectively, ensuring they align with the user's evolving goals and emotional states, enhancing user experience and personalization.

In an example embodiment, text classification that tracks the progression toward a milestone through physical movement and body language is disclosed. When a student approaches a presenter, the process unfolds in four stages: Initiate—where the student focuses on the presenter; Await—a brief pause signaling anticipation; Establish—a nod or head incline indicating recognition and readiness; and finally, start—where the student begins to move toward the presenter.

The text filter in the system allows users to refine their search queries by filtering specific terms or attributes. This component structures the emotional or expressive aspects of the input. For example, the system might identify the required attributes or traits in each of the identified aspects. (posture, facial elements, body elements, objects being held or carried, social interaction type with other entities, backdrop, filtering can be based on provided instructions such as which descriptive text to include or exclude. For instance, the backdrop should contain x but not x1. attire should be x2, x3 or x4 but not x5 etc. similarly for other aspects such as body posture should be standing or sitting. Apart from these exclusions can be based on cultural norms such as excluding, sensitive/private, content etc., It helps adjust image retrieval preferences by excluding certain elements (such as attire or location) that may not match the user's goals or context, which ensures personalized search results by tailoring the content to the user's exact needs, enabling more precise image organization and progression tracking.

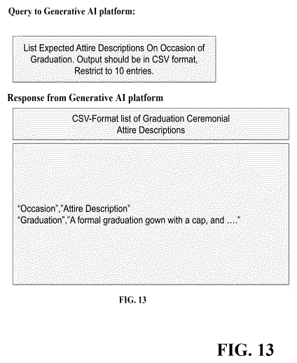

In an example embodiment, a process of using Generative AI to determine and describe expected attires for a subject in photographs taken on various occasions is disclosed in FIG. 13. The system applies text filtering to structure responses by breaking down each entity, including attire, into clearly defined attributes. “Attire<Graduation>” could be structured as: Genre={Formal}, DressingStyle={Gown}, Part={Cap}, AssociationStrength=100%. This helps to objectify the components of each image. The response structure is adapted to different database types, including NoSQL or SQL, for efficient data processing. One way to populate the Aspect Library is by queries generated by the query generator, analysing each image's aspects.

The query processing unit uses AI to refine and process the classified queries. This unit ensures that the queries are not only syntactically correct but also contextually aligned with the user's goals. This is the core engine that processes the filtered query using either a generic AI platform (like GPT, BERT) or a custom solution. This unit ensures the query is handled at scale, processes the query in the context of the recognized aspects, and transforms it into usable information for downstream tasks. Depending on the system's architecture, this could involve a general AI model that integrates the recognized aspects, or it might use a domain-specific AI trained on the platform's knowledge to process the query effectively and provide insights. By processing these queries, the system generates optimized image descriptions that reflect the specific aspects with corresponding progression values identified in the previous stages. These descriptions become the backbone for the subsequent image search. Generative AI tooling enhances the quality of the queries by learning from user input and adjusting for more accurate results. The system will use these refined queries to guide the image search process, ensuring that the images returned are in line with the user's expectations for each milestone. This step is vital for ensuring the overall accuracy and relevance of the visual content presented to the user. Using insights gained from previous steps, the image description builder generates detailed, structured descriptions for each image that aligns with the identified milestones. These descriptions specify the key attributes including attire, facial expressions, body language, and contextual details like location or backdrop. For instance, a milestone like “receiving a degree” will have a description emphasizing a proud facial expression, academic attire, and a graduation ceremony backdrop. By creating these descriptions, the system ensures that every image selected or generated aligns with the specific aspects and milestones, reflecting the user's journey accurately. The image descriptions are used as the foundation for searching and filtering visual content, ensuring that the selected images meet the required standards, which guarantees that the final visual output is both accurate and meaningful. Resulting information model would be as follows: Context 1, Milestone 1: (aspect 1: initial stage, . . . final stage) . . . (Aspect n: initial stage, . . . , final stage), Milestone 2: (aspect 1: initial stage, . . . , final stage) . . . (aspect n: initial stage . . . , final stage), Milestone m: (aspect 1: initial stage, . . . , final stage) . . . (Aspect n: initial stage . . . , final stage).

Repeat for all Contexts. After the image descriptions have been generated, the image and search recognizer searches for visuals that match these detailed descriptions. This system may use image recognition technology to identify relevant images from external sources or AI-generated images to match the described attributes. It can either use image recognition directly or use a GAN to generate a close enough image, or use commercial text-image generators such as PartiPrompts, or use text mining algorithms to match descriptive text that describes an image. The search process is extensive, scanning multiple platforms to find images that align with the specified milestones and aspects. The image recognizer also ensures that images selected during the search are appropriately categorized and linked with the right context. For a given context, image recognizer can identify initial stage and desired stage for each aspect by milestone (that is leading to milestone and further from one milestone to another milestone) By integrating image recognition capabilities, the system ensures that only the most accurate and relevant visuals are presented to the user, providing them with an effective way to track and visualize their goals, which enhances the system's ability to provide meaningful visual content tailored to the user's personal milestones.

The system also employs recursive querying to compare original images alongside similar ones. This recursive approach helps the user visualize not only the immediate goal but also the journey leading up to it. By presenting multiple versions of a given moment or milestone, the system allows the user to analyse subtle changes and progressions. This comparative method helps the user gain a deeper understanding of their goals and accomplishments. Additionally, the system identifies any missing objectives or milestones that need to be added. By comparing different visual representations, the system suggests the addition of new milestones or even smaller stages that could enhance the overall visual narrative. Recursive querying thus serves as both a comparison tool and a means of identifying gaps in the visual documentation process.

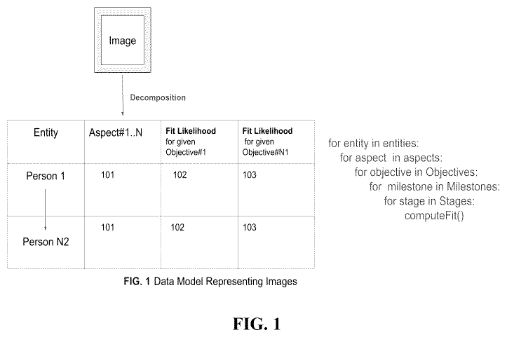

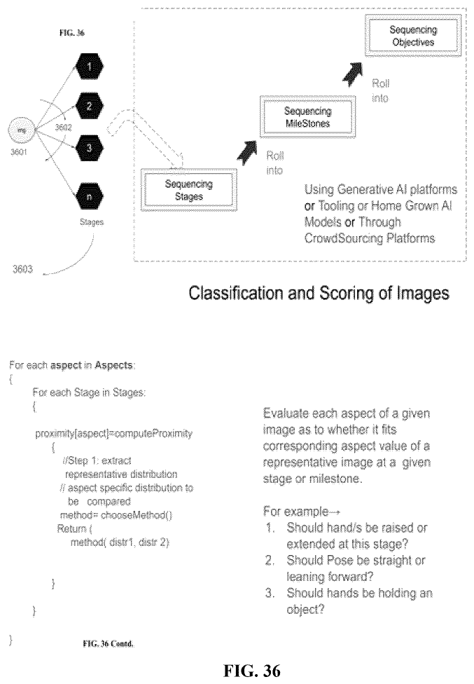

In one example embodiment, FIG. 33 depicts a sequence built through a recursive process where a sequence of events is generated within a given context. The user-provides the context or the system derives the context as graduation, that is fed to the query generator, the system iteratively asks, “What Precedes?” to generate related milestones (e.g., “Receiving Degree,” “Taking Exam,” “Attending Classes”, and the like) along with the related query and response. For each milestone, the system creates image search queries to verify or provide evidence of each moment. The process emphasizes building a temporal or logical sequence of events, using recursive queries to ensure a logical progression toward the final milestone. The score calculator evaluates each image's relevance to the user's goals and milestones by comparing the vectorized embeddings of the attributes defined earlier in the given image with those from the representative image using a chosen distance criterion such as but not limited to Wasserstein Distance. It scores the images based on how closely they match the specified attributes, including facial expression, attire, body language, and location, FIG. 1 provides an illustration. If none of the images meet the required standards, the system will either refine the search with adjusted parameters or prompt the user for more specific preferences, which ensures that the final images accurately reflect the milestones and progression stages. The score calculator helps prioritize images that best represent the key milestones in the user's journey, sorting them by relevance and quality, which helps streamline the image selection process and ensures that the images presented are the best possible match, as illustrated in the FIG. 36.

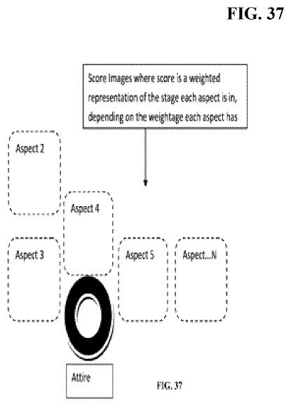

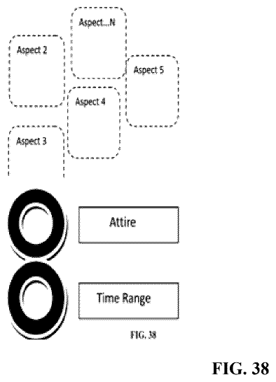

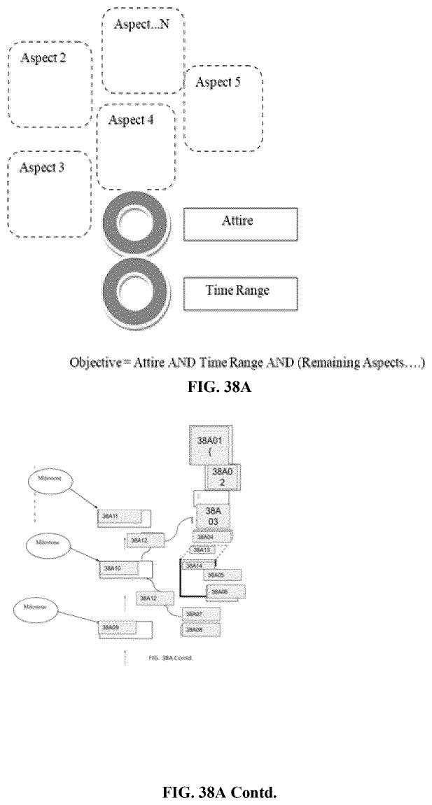

In one example embodiment, the system scores images based on a weighted analysis of various aspects as illustrated in FIG. 37, FIG. 38 and FIG. 38A. Each image is evaluated across multiple criteria, termed “aspects,” with a numerical score reflecting the stage of a process or event captured. These aspects may include features like “attire” or “facial expression,” or “body pose” which are assigned a “stage” (e.g., seated, standing, walking) to indicate progression. Each aspect is given a “weightage,” determining its importance in the final score-more significant aspects contribute more heavily. The system handles multiple aspects, as shown by “Aspect 2,” “Aspect 3,” “Aspect 4,” and so on, representing distinct characteristics evaluated in the image. The individual aspect scores are aggregated into a final weighted score. There can be multiple mechanisms of determining which aspect is relatively stationary versus others. Multiple experiments can be done in a systematic exploration setup (Design of Experiments) wherein which aspect serves as “triggers” for other aspects to undergo a state transition can be methodically determined. Intuition is that facial expressions will not change into a nod or smile randomly on the street but typically only when someone sees a familiar face. A shake hand cannot be triggered randomly on the street but only when an appropriate person is gazed at along with reciprocity. A hand will be extended to collect an object such as degree or diploma only at an appropriate venue such as a dias or podium. Machine learning models can be trained to perform correlation, and causation analysis based on feature sets extracted from context wise labelled images (step-0 all graduation photos where students are seated and waiting in anticipation and more so, and step-1, all graduation photos with handshakes, or with collecting degrees/diploma certificates, in order to show a step change in facial expressions, body language, social interactions such as hand shake etc., based on location change i.e. from graduation hall to podium.) in a form of supervised learning. The rules of triggering behavior can be learned through classification algorithms such as but not limited to decision trees or random forests or support vector machines. Frequency table approach is another possible implementation approach where each potential source aspect is treated as a category with discrete values (such as Location A, B, or C) and observed for positive or negative correlation with another aspect, one at a time, such as Facial Expression Genre-1, Genre-2, Genre-3 and more so.)

| | Facial | | Social |
|---|---|---|---|
| | Expression | Body Pose | Interaction |
| Location | Label | Label | Label |
| Graduation | Tense, | Seating Errectly | None/No Label |
| Hall | Anticipation | (Covariation | |
| | | with Facial | |
| | | Expression such | |
| | | as Tense) | |
| | | Tense-- | |
| | | associated with - | |
| | | Erect Posture | |
| On the | Label 1 | Standing | Waved OR |
| Podium | Changed to | | Extended hand |
| | Relaxed | | for handshake |
| | Smile, Slight | | |
| | Nod of Face | | |

Co-relations thus, can be learnt as to which aspect step change transition causes a corresponding step change transition in other aspects. As illustrated above, it is the location value that causes a step change in facial expressions and social interaction aspect respectively.

This learning in the form of rulesets as obtained from classification techniques, can then be applied to determine most significant aspects that can trigger a change in remaining one or more aspects, for each such aspect. Then, a multivariable regression approach can be adapted to arrive at weights or attribution for one or more such aspects. Outcome is analyzed in two steps. Step 1 is to determine significance versus non significance (p-value is one such statistical measure), Step 2 is to determine the weights arrived at for significant aspects that are expected to cause a state transition from Progressive Stage or Milestone n to Progressive Stage or Milestone n+1.

Here is a tabular representation→Towards Objective of Signing Accord.

| | Facial | | Social | Person- |
|---|---|---|---|---|
| | Expression | | Interaction | Object |
| | Label | Body | Label | Interaction |
| Progressive | (Signifi- | Pose | (Signifi- | (Signifi- |
| Stage or | cant == | Label | cant == | cant == |
| Milestone | False) | (False) | True) | True) |
| Stage n − 1 | | | Shake Hands | Hold Accord |
| (prior to | | | (Attribution→70%) | Document |
| signing | | | Nod | folder (20%) |
| accord) | | | (Attribution→10%) | |
| Stage n + 1 | | | Shake Hands | Exchange |
| (after | | | (Attribution→50%) | Document |
| signing | | | | Folder |
| accord) | | | | (Attribution |
| | | | | →50%) |

An illustration of the cuboid as illustrated in FIG. 19 depicts how % weight attribution per aspect can be applied in yet another context of graduation and visualized for 3 aspects simultaneously (hence cuboid as it represents 3 aspects as dimensions). The idea is that some aspects have binary TRUE/FALSE representation. For instance, Attire is either appropriate (1) for the occasion or not (0). The person is at the expected location (1) or not (0). This is depicted as {1|0}. These represent wheels of the cuboid. So, a 3 dimensional cuboid representing an equal number of aspects standing on stationary wheels (a trolley effect) of binary aspects. In this model, the subject changing attire as he moves to another location or at another time can be symbolized as the cuboid being moved on the wheels.

This final score quantifies the overall stage or progression depicted in the image. This method is applied in various fields like image classification, content moderation, or behavioural analysis, providing a comprehensive measure of the image's context. The system allows for flexibility with variable numbers of aspects and tailored scoring based on their relative importance. Attire operates as a Boolean multiplier, evaluated strictly as a binary condition: it is either appropriate or inappropriate for the occasion. The system does not assign a score for how “well-dressed” someone is; it checks if the attire is suitable for the event or context. If the attire is deemed appropriate, it positively impacts the score; if it is inappropriate, it negatively affects the evaluation. While other aspects are scored based on their weightage, attire must meet the condition of appropriateness for the overall score to reflect a positive outcome. This makes attire a critical, mandatory condition for success.

In another example embodiment, the system dynamically weights different aspects when analysing progress toward a milestone, adjusting their importance based on the specific context. Aspects including as Physical Motion, Facial Expressions, Social Interactions, and Attire are assigned weights, represented as “[XY] %,” reflecting their relevance to the milestone, as illustrated in FIG. 19. When analysing “Receiving Grade,” Physical Motion may have less significance, while Social Interactions and Facial Expressions before and after receiving the grade are prioritized. The system considers time-sensitive factors, indicated by “1/0” on the timeline, to ensure that the most relevant aspects are given the appropriate weight for accurate milestone evaluation.

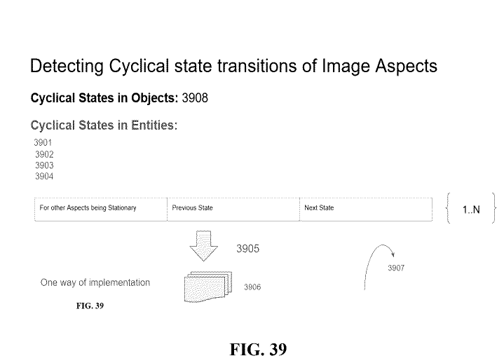

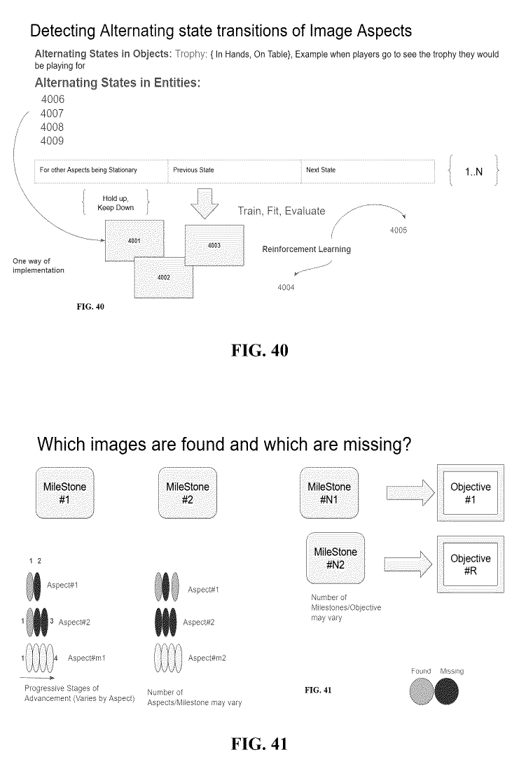

In another example embodiment, the system analyses and processes multiple aspects of a situation or event, with particular emphasis on “Attire” and “Time Range,” as illustrated in FIG. 38. Aspects including Physical Motion, Social Interactions, and Facial Expressions are considered, with a flexible number of aspects depending on the context. “Attire” is treated as a critical factor, while “Time Range” operates as a Boolean multiplier, determining whether the event occurs within a specific time limit. If a student is dressed in a graduation gown and interacting with the right people at the right venue, but the event occurs before the actual graduation day (it could be a rehearsal or cold trial for instance), the objective cannot be achieved. The system ensures that all aspects, including the appropriate timing, are met before declaring the objective accomplished, thus prioritizing both attire and the correct time range in the milestone evaluation. The other example processes are illustrated in FIGS. 20, 39 and 40.

The image presentation system categorizes and organizes the images based on their relevance to the specific milestone stages. It ensures that the images provided to the user are complete, relevant, and aligned with the context of the milestones. The system checks for completeness, ensuring all necessary aspects of each milestone are captured visually. If any aspect is missing or not accurately represented, the system prompts the user to modify or add additional images to fill the gap. This step is critical to ensuring that the user's journey is represented accurately and comprehensively. The image presentation system ensures that users receive organized visual representations of their goals and milestones, providing a cohesive, engaging visual experience.

The nudge/prompter module generates multimedia prompts to help the user identify any missing images, ensuring the visual representation of their milestones is complete. Nudges include notifications, reminders, or suggestions based on the milestones identified earlier in the process. These nudges encourage users to capture additional images or modify existing ones to better reflect their journey. This module supports users in staying on track with their goals and ensures the system's final output aligns with their journey. If any key aspect is missing or incomplete, the system flags it, prompting the user to provide additional images or adjust existing ones, while also confirming various aspects or context. Continuous analysis ensures the system maintains a coherent progression of visual milestones, depicting the user's journey in the most precise and contextual manner possible, enhancing the overall user experience.

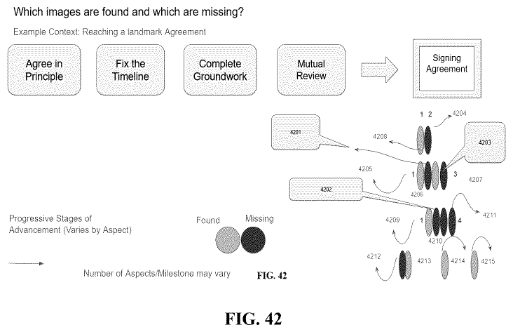

In one example, the system tracks progress by identifying completed and missing elements, which involves defining milestones and objectives, then breaking down each milestone into specific aspects to pinpoint which are complete and which are missing, as illustrated in the FIG. 41. In a landmark agreement context, the system identifies the missing aspect in the milestone and enables the nudge/prompter module to prompt the user for adding the missing information or image, as illustrated in the FIG. 42.

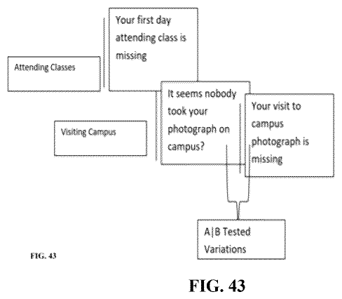

In one example embodiment, the FIG. 43 discloses the system triggering the objective completion recommendations provided for each context and milestone, suggesting missing images as part of the progressive attainment of the milestone. When an automated search fails to find relevant images, a program can generate and trigger recommendations based on a detailed description of the image, which includes specific attributes including facial expression, body language, motion aspects, objects in hand or frame, attire, backdrop, and timeline, which help ensure that all necessary aspects are represented visually, allowing for a comprehensive and accurate depiction of the milestone and objective.

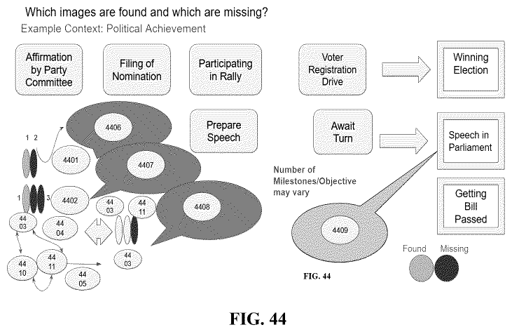

In another example embodiment, FIG. 44 presents a framework for evaluating progress in a political campaign or career. It tracks “found” (completed) and “missing” (incomplete) aspects across key milestones like party affirmation, nomination filing, rallies, and voter registration, culminating in winning the election. Each milestone comprises specific actions, including attire changes, speech preparation, and voter outreach. Progress is visually tracked, with the nudge/prompter module highlighting missing elements like photos, speeches, or interactions with the public. This system emphasizes the importance of both major milestones and smaller, symbolic actions, enabling Subject to identify gaps and strategically address them to enhance their chances of success.

In another example embodiment, FIG. 7 depicts the input image showing a subject (face) wearing a navy-blue striped shirt and tie against a backdrop resembling a plastered wall. A list of emotions (Joy, Anger, Fear, etc.) is either provided (or generated through analysis of facial expressions through commonly known algorithms), as initial tags or filters. The system then checks for additional context. If unavailable, it proceeds with default analysis and uses gen AI to analyse both the subject's attire and the background. Well known AI algorithms as referred to in [00107] identifies the subject as “happily looking at the camera” in formal wear. The prompter asks the user if they wish to proceed with the current attire and backdrop. If “yes” is selected, the process continues, involving the generation of a detailed description (not shown). This system combines image recognition with generative AI, through use of commercially or freely available tooling to create a textual summary of the subject's appearance and contextual information, enhancing understanding of the subject's emotional state and setting.

The zoom-in/zoom-out module offers users the ability to control the level of detail in their visual progressions. Zooming out allows the user to see an overview of their journey, highlighting key milestones and broad changes, while zooming in focuses on the finer, more granular changes that occur within specific stages. Same capability can be offered to an pre-identified and selected object from the image, where context, objective and milestones are generated through prompts to commercially or freely available generative ai tooling. If the object is a body cell or tissue, the context is “cancer” and the objective being “recovery”, corresponding recovery stages in the disease can be sought through recursive querying. This dual functionality provides users with greater flexibility in how they view their progress, allowing for both a high-level overview and an in-depth examination of specific moments or changes. By offering zoom-in and zoom-out options, the system enhances the user's experience, providing a more dynamic and flexible way to explore their journey.

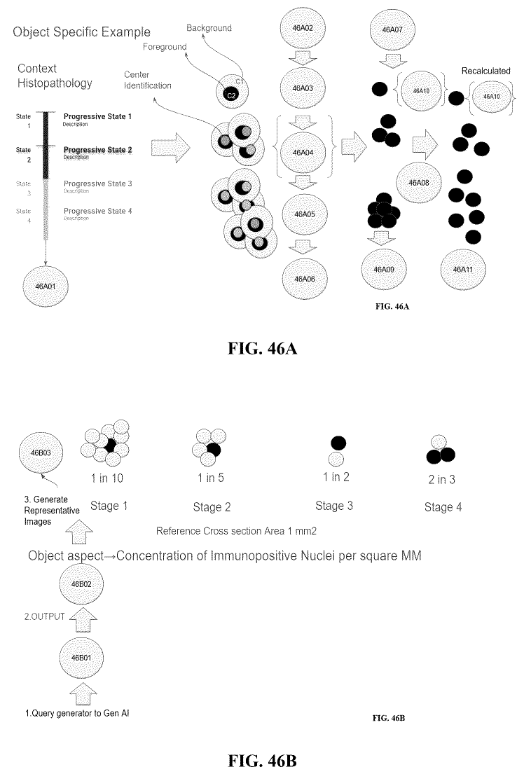

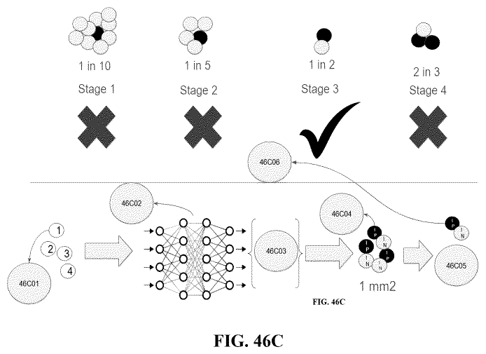

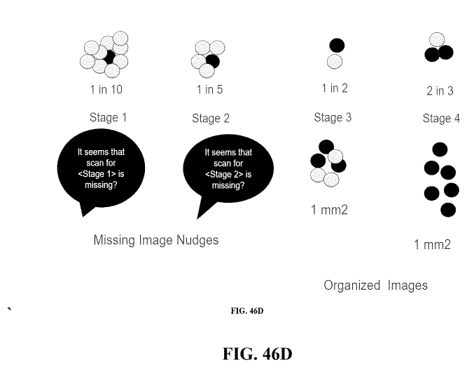

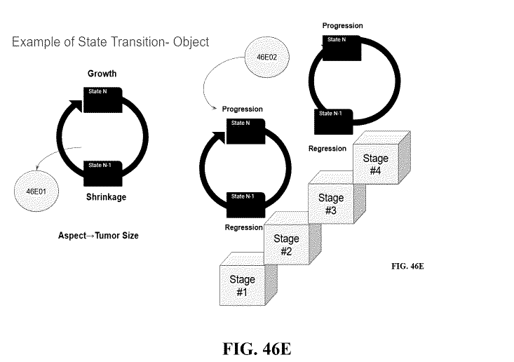

In an example embodiment, a user organizes wedding photos through the app by selecting the “Wedding” context and setting goals, including creating a narrative centered around milestones like the “ceremony,” “reception,” and “speeches.” After uploading photos, the context recognizer analyses them using computer vision, confirming the wedding context by incorporating user inputs like voice and location. The milestone generator identifies predefined milestones and suggests additional ones using generative AI. The aspect recognizer assesses images for details including facial expressions, attire, and settings, while the image description builder creates structured descriptions that align with the identified milestones. The system then searches for matching visuals through image recognition and recursive querying, allowing users to visualize their journey effectively. A score calculator evaluates the relevance of each image based on specified attributes, presenting an organized visual narrative of the wedding day and identifying any missing milestones, with suggestions provided through nudges to help the user create a meaningful representation of their special day. In another example embodiment, a user organizes photos from a day out with friends using the app, is disclosed. The user selects the “Day Out” context, sets goals like creating a narrative, and defines milestones including “leaving home,” “arriving at the jetty,” and “returning home.” The context recognizer analyses uploaded photos using computer vision and user input (voice, location) to confirm the context. The milestone generator suggests predefined and AI-generated milestones, like “boarding a boat.” The aspect recognizer identifies key details including attire and transportation mode by retrieving corresponding aspect specific framework from the aspect library or based on the output from a home grown or third party generative ai platform which is fed with a corresponding query generated by query generator component. The image description builder creates structured image descriptions that align with the identified milestones. The system searches for matching visuals using detailed descriptions and evaluates or scores images for relevance to the goals. It also suggests missing milestones and photos that show changes in attire or transportation, including casual to formal attire or bike to boat. The system helps the user create a cohesive, meaningful visual narrative of their day out. In yet another example embodiment pertaining to a monitoring progression of a specific object within an image, as illustrated in FIGS. 46A-E, a patient or treating medical professional can organize disease treatment outcome photos where selected context is recovery from disease/disorder. In this specific embodiment, the object of interest is nuclei of cells from tissue samples taken from a biopsy as a snapshot of disease appearance or progression or recovery thereof. The outcomes themselves can be but not limited to count of infected regions, spread in terms of length and breadth of infections in organs, count or concentration of cancerous or tumor cells by the region, as illustrated in FIG. 46A, wherein nuclei regions and boundaries detected by arriving at segmentation masks and distance masks using a variety of known algorithmic techniques such as Otsu method or deep learning based U-net method, further classified as nuclei of cells Versus Other objects or regions using classification algorithms such as Support Vector Machines, and finally a deep learning neural network trained on various features such as but not limited to size, shape, color/pigmentation, type, count, and density, to classify nuclei as immuno-positive or negative. The objective or goals of recovery are set such as but not limited to Stage 3, Stage 2, Stage 1 etc as illustrated in FIG. 46A and FIG. 46B. The context recognizer analyses uploaded photos using computer vision and user input (voice, location) to confirm the context. The milestone generator suggests predefined and AI-generated milestones, like “stage 1”, as illustrated in FIG. 46B, The aspect recognizer, as illustrated in FIG. 46B, identifies key aspects such as dimension which is expressed as concentration of immunopositive tumor cells per square millimeter versus otherwise, and map expected concentration per square millimeter to each progressive stage based on a previously stored aspect specific framework from aspect library or based on output from a home grown or third party generative ai platform which is fed with a corresponding query generated by query generator component, for an associated biomarker such as but not limited to ki-67. As illustrated in FIG. 46C, the image description builder creates structured descriptions that align with the identified milestones or stages associated with this specific disease or disorder progression, the corresponding representative images may be generated by inputting this generated description to a home grown or commercial text-image generative ai platform, the system searches for matching visuals using detailed descriptions and evaluates or scores images for relevance to the goals. It also suggests missing milestones and photos that show changes in biomarker concentration as illustrated in FIG. 46D, including the length corresponding to Stage m to Stage m+1 or from stage m−1 to m. The system helps the user create a cohesive, meaningful visual narrative of their suffering and subsequent recovery from disease/disorder via a given treatment.

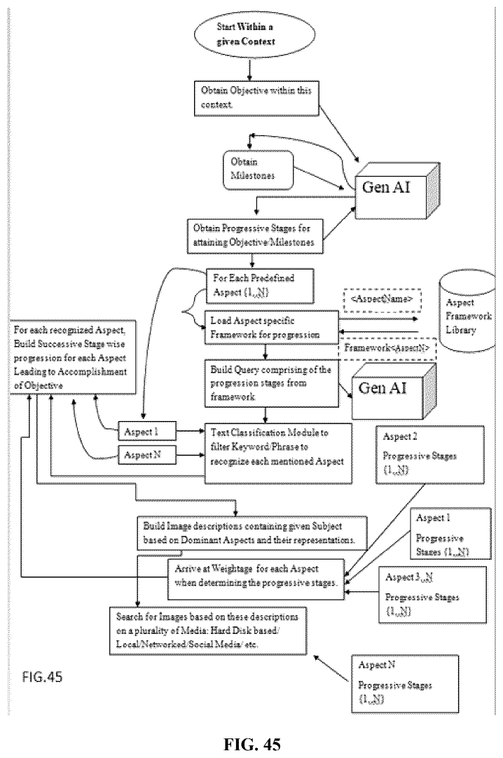

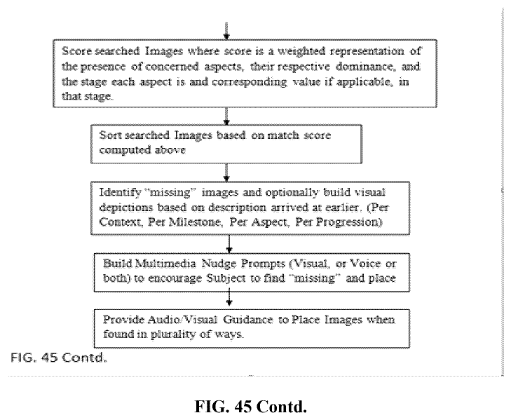

A process for classifying and recommending images based on an analysis of a subject's or object's goals and objectives as illustrated in the FIG. 45, comprising the steps of:
a) initiating the process by prompting the user to provide information about their goals or objectives related to significant life events, recovery phases, or event participation, through a user interface;
b) receiving contextual input from a user, including life events, goals, recovery phases, and event participation, to identify specific objectives and milestones through a context recognizer;
c) generating progressive milestones for the identified event context, where each milestone represents a significant key achievement or goal across the progression timeline of the event, using a milestone generator;
d) identifying and analysing specific event aspects that need to be represented in images for each milestone, including attire, facial expressions, body language, posture, and location, various types of dimensions such as count, length, breadth, height, angle of incline, diameter, concentration such as given count divided by given area in case of object, through an aspect recognizer and visual analysis component, to understand intent and generate representations of goal achievement;
e) decomposing images associated with the context and milestones into detailed aspects, including entities, emotive expressions, facial expressions, body language, posture, attire, various types of dimensions such as count, length, breadth, height, angle of incline, diameter, concentration such as given count divided by given area in case of object, and context-related keywords, using an aspect recognizer for deeper analysis of the image content;
f) searching for visual representations of objectives and milestones matching the required stages involves generating specific queries based on identified milestones, recognized aspects, and context, specifying attributes that should be present in the images, with the help of a query generator.
g) filtering the generated queries based on user preferences or contextual exclusions including attire or location, or a dimension using a text filter to refine the search criteria;
h) classifying keywords from the filtered queries into predefined categories including “goal,” “milestone,” and “progress or stage” to map the attributes to aspects and stages of the milestones, through a text classifier;
i) processing the classified queries to generate image descriptions that align with the identified milestones and aspects, facilitated by a query processing unit;
j) recognizing and tracking the successive progression of aspects in images to identify how each aspect evolves over time and how it maps to the milestones, through an aspect recognizer, wherein the system evaluates whether the milestones should proceed as planned or require adjustments, including when a crucial aspect is missing, or progress is insufficient, prompting the user to provide additional information, update milestones, or review previously captured images;
k) generating descriptions for images that align with each milestone and aspect, specifying appropriate attributes including location, attire, expression, interaction, or backdrop, using an image description builder;
l) searching for images that match the generated descriptions through image and search recognizer either by using image recognition or AI-generated images;
m) employing recursive querying to present original images alongside similar ones and analyse moments leading to milestones, helping the user compare their or a given subject's or object's goals and accomplishments and suggesting missing objectives to be added;
n) detecting and matching types of successive progression states in stages, including cyclical/non-cyclical and alternating/non-alternating patterns in the milestones, to enhance understanding of the progression dynamics, through an aspect recognizer;
o) scoring and sorting the matched images based on how closely they align with the required aspects and milestones, through a score calculator, wherein
   the system evaluates the image that matches to determine if the results meet the required milestones. If none of the images align, the system decides whether to refine the search with modified parameters, adjust the image descriptions, or prompt the user for more specific preferences;
p) presenting the organized images to the user, categorizing them based on milestone stages, and ensuring completeness and relevance, using an image presentation system, wherein
   the system assesses the completeness of the visual representation by evaluating whether all necessary aspects of each milestone are accurately captured, ensuring that the images align with the identified milestones, and prompting the user to add or modify images if needed.
q) generating nudges or multimedia prompts to guide the user in identifying and adding missing images, ensuring an accurate visual representation of the milestones, through a nudge/prompter module;
r) enabling zoom-in and zoom-out functionality that allows users to filter out finer change progressions in states (zoom out) and focus on aggregate change or descend into finer change progression from aggregate change (zoom in), through a zoom-in/zoom-out module;
s) providing feedback to the user on how to place the images, ensuring the creation of a coherent visual representation of the journey, through a user interface;
t) repeating the process for additional milestones or new contexts to continuously track and progress the user's goals, facilitated by the milestone generator.
u) powering down the system when no further milestones are required or during maintenance, using the user Interface to control when the system is no longer needed.

In an example embodiment, the process for determining the relative importance of various aspects in academic milestones, including Graduation is illustrated in FIG. 38A. The system identifies the key Milestones (e.g., Course Completion, Receiving Grade, Taking Exam) using the Milestone Generator. These milestones are connected sequentially, where one milestone leads to the next. For each milestone, Progressive Aspects like Attire, Body Language, Person-Person Interaction, Person-Object Interaction, Physical Motion, and Facial Expressions, various types of dimensions in case of object are analysed through the Aspect Recognizer, which tracks their evolution across multiple stages. Must Have aspects represent essential requirements, while Progressive aspects reflect ongoing state transitions recognized as per definitions stored in Aspect Library components. The system collects data from user input, helping to determine the weightage of each aspect. Aspects are assigned attribution weightages (e.g., “30% Wt.”, “50% Wt.”) using the Score Calculator, and queries for image searches are generated by the Query Generator. The Text Filter refines these queries, while the text classifier categorizes the keywords into Goal, Milestone, and Progress/Stages. The image search and recognizer process the images, which are then organized and presented by the Image Presentation System. Missing aspects are identified through the Nudge/Prompter Module, and the Zoom-In/Zoom-Out Module allows detailed progress analysis. The User Interface provides feedback and helps organize the images to create a coherent visual journey, with the Milestone Generator facilitating the addition of new milestones.

The context based image classification, organization and retrieval system offers significant advantages by enhancing user engagement and personalizing visual narratives. It utilizes advanced image analysis techniques to accurately categorize and retrieve images based on emotional, behavioural, and contextual cues, ensuring that users can seamlessly organize their visual content according to their defined goals and milestones. The system's ability to integrate across multiple platforms-mobile devices, tablets, and wearables-provides versatility and accessibility for users. With features like a robust user interface, context recognizer, milestone generator, and intelligent nudging, the system fosters a dynamic experience that encourages users to capture and reflect on meaningful moments in their lives. Additionally, it enhances the organization of images through iterative processing and detailed query generation, providing a comprehensive understanding of user journeys and progress, leading to richer storytelling and personal satisfaction in visual representation.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

1. A context based image classification, organization and retrieval system comprising:
a user interface configured to receive user input related to goals, milestones, and event contexts, and to display organized images with progress visualization and feedback;
a context recognizer, configured to analyze uploaded photographs and user input to determine the intent of subjects within the images, identify goals through visual cues (facial expressions, body language, location, attire, person-person interactions, person-object interactions, various dimensions in case of object etc.), and assess the broader context of the image (events, settings);
a milestone generator, configured to identify relevant milestones within the determined context, providing a structured framework for the user's journey, and using generative AI to suggest additional milestones;
an aspect library, configured to store predefined frameworks that define the progressive stages for various aspects (facial expressions, body language, location, attire, person-person interactions, person-object interactions, various dimensions for a given object) within a given context and milestone, and containing weighting values for each aspect;
an aspect recognizer, configured to analyze the visual content of images to identify and extract detailed aspects aligned with identified milestones and stages, examining elements like facial expressions, body language, location, attire, person-person interactions, person-object interactions, various dimensions for a given object and detecting and matching types of successive progression states;
a visual analysis component, configured to work in tandem with the aspect recognizer to enhance image evaluation and interpretation, employing computer vision algorithms to perform deep analyses and scan images for key visual elements;
a query generator, configured to use generative AI to construct detailed search queries to locate relevant images that match the visual requirements for specific milestones within a given context, incorporating user input and aspect frameworks;
a text classifier configured to classify keywords from filtered queries into predefined categories;
a text filter, configured to allow users to refine their search queries by filtering specific terms or attributes;
a query processing unit, configured to use AI to refine and process the classified queries, ensuring contextual alignment;
an image description builder, configured to generate detailed, structured descriptions for each image, aligned with identified milestones and aspects, specifying key attributes;
an image search and recognizer configured to search for images matching generated descriptions using image recognition and AI-generated images;
a score calculator configured to evaluate image relevance based on alignment with required aspects and milestones;
an image presentation system configured to organize and present images based on milestone stages;
a nudge/prompter module configured to generate prompts to guide the user in identifying and adding missing images;
a zoom-in/zoom-out module configured to control the level of detail in the visual progressions;
a recursive querying, configured to iteratively generate search queries, building upon previous results to identify a sequence of related stages and events and supporting images leading up to a milestone or objective;

2. The context based image classification, organization and retrieval system as claimed in claim 1, wherein the user interface includes a text filter that allows for refinement of search queries by excluding specific attributes.

3. The context based image classification, organization and retrieval system as claimed in claim 1, wherein the context recognizer employs machine learning algorithms to assess the broader context of images, such as events, objectives and associated settings.

4. The context based image classification, organization and retrieval system as claimed in claim 1, wherein the aspect library includes weighting values associated with each aspect associated with a given subject or object to determine their relative importance in image selection.

5. The context based image classification, organization and retrieval system as claimed in claim 1, wherein the query processing unit utilizes generative AI to generate, refine and optimize queries based on a query generation framework.

6. The context based image classification, organization and retrieval system as claimed in claim 1, wherein the nudge/prompter module generates multimedia prompts to assist the user in identifying and managing missing images from their milestones.

7. A process for classifying and recommending images based on an analysis of a subject's or object's goals and objectives, comprising the steps of:
a) initiating the process by prompting the user to provide information about their goals or objectives related to significant life events such as goal or objective achievements, trauma and recovery phases, or event participation, through a user interface;
b) receiving contextual input from a user, including life events, goals, recovery phases, and event participation, to identify specific objectives and milestones through a context recognizer;
c) generating progressive milestones for the identified event context, where each milestone represents a significant key achievement or goal across the progression timeline of the event, using a milestone generator;
d) identifying and analysing specific event aspects that need to be represented in images for each milestone, including facial expressions, body language, location, attire, person-person interactions, person-object interactions, various object dimensions such as but not limited to count, length, breadth, height, angle of incline, diameter, concentration such as given count divided by given area for a given object, through an aspect recognizer and visual analysis component, to understand intent and generate representations of goal achievement;
e) decomposing images associated with the context and milestones into detailed aspects, including entities, facial expressions, body language, location, attire, person-person interactions, person-object interactions, various dimensions such as but not limited to count, length, breadth, height, angle of incline, diameter, concentration such as given count divided by given area for a given object and context-related keywords, using an aspect recognizer for deeper analysis of the image content;
e) searching for visual representations of objectives and milestones matching the required stages involves generating specific queries based on identified milestones, recognized aspects, and context, specifying attributes that should be present in the images, with the help of a query generator.
f) filtering the generated queries based on user preferences or contextual exclusions including facial expressions, body language, location, attire, person-person interactions, person-object interactions, various dimensions such as but not limited to count, length, breadth, height, angle of incline, diameter, concentration such as given count divided by given area for a given object using a text filter to refine the search criteria;
g) classifying keywords from the filtered queries into predefined categories including “goal,” “milestone,” and “progress/stages” to map the attributes to aspects and stages of the milestones, through a text classifier;
h) processing the classified queries using AI-based technology to generate image descriptions that align with the identified milestones and aspects, facilitated by a query processing unit;
i) recognizing and tracking the successive progression of aspects in images to identify how each aspect evolves over time and how it maps to the milestones, through an aspect recognizer, wherein
the system evaluates whether the milestones should proceed as planned or require adjustments, including when a crucial aspect is missing, or progress is insufficient, prompting the user to provide additional information, update milestones, or review previously captured images;
j) generating descriptions for images that align with each milestone and aspect, specifying appropriate attributes including facial expressions, body language, location, attire, person-person interactions, person-object interactions, various dimensions such as but not limited to count, length, breadth, height, angle of incline, diameter, concentration such as given count divided by given area for a given object, using an image description builder;
k) searching for images that match the generated descriptions through image and search recognizer either by using image recognition or AI-generated images;
l) employing recursive querying to present original images alongside similar ones and analyze moments leading to milestones, helping the user compare their or given subject's or object's goals and accomplishments and suggesting missing objectives to be added;
m) detecting and matching types of successive progression states in stages, including cyclical/non-cyclical and alternating/non-alternating patterns in the stages leading to milestones and milestones themselves, to enhance understanding of the progression dynamics, through an aspect recognizer;
m) scoring and sorting the matched images based on how closely they align with the required aspects and milestones, through a score calculator, wherein
the system evaluates the image that matches to determine if the results meet the required milestones. If none of the images align, the system decides whether to refine the search with modified parameters, adjust the image descriptions, or prompt the user for more specific preferences including progression state transitions as in m;
n) presenting the organized images to the user, categorizing them based on milestone stages, progression state transitions as in m and ensuring completeness and relevance, using an image presentation system, wherein
the system assesses the completeness of the visual representation by evaluating whether all necessary aspects of each stage leading to milestones and milestones themselves are accurately captured, ensuring that the images align with the identified milestones, and prompting the user to add or modify images if needed.
o) generating nudges or multimedia prompts to guide the user in identifying and adding missing images, ensuring an accurate visual representation of the milestones, through a nudge/prompter module;
p) enabling zoom-in and zoom-out functionality that allows users to filter out finer change progressions in states (zoom out) and focus on aggregate change or descend into finer change progression from aggregate change (zoom in), through a zoom-in/zoom-out module;
q) providing feedback to the user on how to place the images, ensuring the creation of a coherent visual representation of the journey, through a user interface;
r) repeating the process for additional milestones or new contexts to continuously track and progress the user's goals, facilitated by the milestone generator.
s) stopping the system when no further milestones are required or during maintenance, using the user Interface to control when the system is no longer needed.

8. The process as claimed in claim 7, further comprising the step of decomposing images into entities, objects, facial expressions, body language, location, attire, person-person interactions, person-object interactions, and context-related keywords for a deeper analysis of image content.

9. The process as claimed in claim 7, wherein the score calculator evaluates images by scoring them against multiple aspects, along with progression dynamics such as cyclical/non-cyclical, alternating state transitions with weightages reflecting their importance to the milestone achievement.

10. The process as claimed in claim 7, wherein the recursive querying mechanism identifies and presents a structured sequence of events leading to milestones, enhancing user tracking of progress over time.
